(19) United States
(12) Patent Application Publication
(10) Pub. No.: US 2024/0014020 A1
(43) Pub. Date: Jan. 11, 2024

(54) SYSTEMS AND METHODS FOR IMPROVED MASS ANALYSIS INSTRUMENT OPERATIONS

(71) Applicant: DH Technologies Development Pte. Ltd., Singapore (SG)

(72) Inventors: Daniel CARLISLE, Amesbury, MA (US); Michael J. LAWRENCE, Sunderland (CA); Selvakumaran RAJAMANICKAM, Argyle, TX (US); Ali Nikbakht REZAZADEH, Richmond Hill (CA); Edmond Chi-Chiu SIU, Markham (CA); Greg SPRAH, Golden (CA)

(73) Assignee: DH Technologies Development Pte. Ltd., Singapore (SG)

(21) Appl. No.: 18/036,461

(22) PCT Filed: Nov. 19, 2021
(86) PCT No.: PCT/IB2021/060767

§ 371 Date: May 11, 2023

Related U.S. Application Data
(60) Provisional application No. 63/115,903, filed on Nov. 19, 2020.

(51) Int. Cl. H01J 49/00

(52) U.S. Cl. CPC H01J 49/0009

(57) ABSTRACT

The technology relates to a system for improved mass analysis operation by proactively identifying contamination. The system includes a mass analysis instrument comprising mass analysis hardware components, a processor, and memory storing instructions that, when executed by the processor, cause the system to perform a set of operations. The set of operations include performing, by the mass analysis instrument at a first time, a predefined series of operational tests to produce first mass analysis results for a calibrant; performing, by the mass analysis instrument at a second time, the predefined series of operational tests to produce second mass analysis results for the calibrant; determining an analysis difference between the first mass analysis results and the second mass analysis results; and based on a magnitude of the analysis difference, generating at least one of a contamination indicator or a degradation indicator.

### CROSS REFERENCE TO RELATED APPLICATIONS

This application is being filed on Nov. 19, 2021 as a PCT International Patent Application and claims the benefit of and priority to U.S. Provisional Application No. 63/115,903, filed on Nov. 19, 2020, which application is hereby incorporated herein by reference.

### INTRODUCTION

Mass analysis instruments, such as mass spectrometers, are generally used to characterize the composition of samples, including for instance, pharmaceutical samples in drug trials, and the like. Mass spectrometry (MS) is an analytical technique for determining the elemental composition of test substances with both qualitative and quantitative applications. MS can be useful for identifying unknown compounds, determining the isotopic composition of elements in a molecule, determining the structure of a particular compound by observing its fragmentation, and quantifying the amount of a particular compound in a sample, among other things. Given its sensitivity and selectivity, MS is particularly important in life science applications. A laboratory may have one mass analysis instrument or hundreds, depending upon their needs. Some laboratories require more uptime of mass analysis instruments during the daytime (e.g. university lab), while a testing laboratory (such as a Contract Research Organization, or “CRO”) may require 24/7 availability.

Over time, mass analysis instruments may have components that wear and may ultimately fail. In addition, throughout usage of the mass analysis instruments, the mass analysis instruments may become internally contaminated from the samples that are being analyzed. As the components degrade or become contaminated, the operation and accuracy of the mass analysis instruments may be negatively affected.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for improving operation of mass analysis instruments. In an aspect, the technology relates to a system for improved mass analysis operation by proactively identifying contamination. The system includes a mass analysis instrument comprising mass analysis hardware components, a processor, and memory storing instructions that, when executed by the processor, cause the system to perform a set of operations. The set of operations include performing, by the mass analysis instrument at a first time, a predefined series of operational tests to produce first mass analysis results for a calibrant; performing, by the mass analysis instrument at a second time, the predefined series of operational tests to produce second mass analysis results for the calibrant; determining an analysis difference between the first mass analysis results and the second mass analysis results; and based on a magnitude of the analysis difference, generating at least one of a contamination indicator or a degradation indicator.

In another aspect, the technology relates to a method for improved mass analysis operation by proactively identifying at least one of contamination or degradation. The method includes performing, by the mass analysis instrument at a first time, a predefined series of operational tests to produce first mass analysis results for a calibrant; performing, by the mass analysis instrument at a second time, the predefined series of operational tests to produce second mass analysis results for the calibrant; determining an analysis difference between the first mass analysis results and the second mass analysis results; and based on a magnitude of the analysis difference, generating at least one of a contamination indicator or a degradation indicator.

In another aspect, the technology relates to a method for improved mass analysis operation by proactively identifying at least one of contamination or degradation. The method includes accessing first mass analysis results produced from a mass analysis instrument performing a predefined series of operational tests for a calibrant at a first time; accessing second mass analysis results produced from the mass analysis instrument performing a predefined series of operational tests for the calibrant at a second time; determining an analysis difference between the first mass analysis results and the second mass analysis results; and based on a magnitude of the analysis difference, generating at least one of a contamination indicator or a degradation indicator.

In another aspect, the technology relates to a system for improved mass analysis operation by proactively identifying contamination or degradation. The system includes a mass analysis instrument comprising mass analysis hardware components, a processor, and memory storing instructions that, when executed by the processor, cause the system to perform a set of operations. The set of operations include storing, at a first time, first machine-level characteristics for the mass analysis instrument; storing, at a second time, second machine-level characteristics for the mass analysis instrument; determining a machine-level difference between the first machine-level characteristics for the mass analysis instrument; and based on the machine-level difference, generating at least one of a contamination indicator or a degradation indicator.

In another aspect, the technology relates to a system for improved mass analysis operation by identifying at least one of contamination or degradation, the system includes a mass analysis instrument comprising mass analysis hardware components, a processor, and memory storing instructions that, when executed by the processor, cause the system to perform a set of operations. The set of operations include performing, by the mass analysis instrument at a first time, a predefined series of operational tests to produce first mass analysis results for a calibrant; performing, by the mass analysis instrument at a second time, the predefined series of operational tests to produce second mass analysis results for the calibrant; performing, by the mass analysis instrument at a third time, the predefined series of operational tests to produce third mass analysis results for the calibrant; determining a first analysis difference between the first mass analysis results and the second mass analysis results; determining a second analysis difference between the second mass analysis results and the third mass analysis results; determining a third analysis difference between the first difference and the second difference; and based on a magnitude of the third difference, generating at least one of a contamination indicator or a degradation indicator.

In another aspect, the technology relates to a system for improved mass analysis operation by proactively identifying contamination or degradation. The system includes a mass analysis instrument comprising mass analysis hardware components, a processor, and memory storing instructions that, when executed by the processor, cause the system to perform a set of operations. The set of operations include performing, by the mass analysis instrument at a first time, a predefined series of operational tests to produce first mass analysis results for a calibrant; performing, by the mass analysis instrument at a second time, the predefined series of operational tests to produce second mass analysis results for the calibrant; providing the first mass analysis results and the second mass analysis results into a trained machine learning model, wherein the trained machine learning model has been trained on prior mass analysis results from a plurality of mass analysis instruments; and generating, as output from the trained machine learning model, at least one of a contamination indicator or a degradation indicator.

In another aspect, the technology relates to a system for improved mass analysis operation by proactively identifying contamination or degradation. The system includes a mass analysis instrument comprising mass analysis hardware components, a processor, and memory storing instructions that, when executed by the processor, cause the system to perform a set of operations. The set of operations include performing, by the mass analysis instrument, a predefined series of operational tests at multiple times to produce a plurality of mass analysis results for a calibrant; generating a trend of the mass analysis results; comparing the trend to a trend threshold; and based on the comparison of the trend to the trend threshold, generating at least one of a contamination indicator or a degradation indicator.

In another aspect, the technology relates to a system for improved mass analysis operation by proactively identifying contamination or degradation. The system includes a mass analysis instrument comprising mass analysis hardware components, a processor, and memory storing instructions that, when executed by the processor, cause the system to perform a set of operations. The set of operations include detecting a first cleaning of the mass analysis instrument at a first time; tracking first instrument usage data for mass analysis tests performed between the first time and a second time; detecting a second cleaning of the mass analysis instrument at the second time; tracking second instrument usage data for mass analysis tests performed after the second time; and based on a time interval between the first time and the second time, the first instrument usage data, and the second instrument usage data, generating a contamination indicator.

In another aspect, the technology relates to a system for improved mass analysis operation. The system includes a processor and memory storing instructions that, when executed by the processor, cause the system to perform a set of operations. The set of operations include detecting hardware replacement events for a plurality of mass analysis instruments; tracking instrument usage data for the plurality of mass analysis instruments; determining time durations between the hardware replacement events; based on the instrument usage data and the determined time durations, determining at least one hardware component lifetime; generating degradation indicators for one or more mass analysis instruments in the plurality of mass analysis instruments; executing a hardware query based on the generated degradation indicators; and based on results of the hardware query, executing a hardware replenishment process.

In another aspect, the technology relates to a system for improved mass analysis operation. The system includes a processor and memory storing instructions that, when executed by the processor, cause the system to perform a set of operations. The set of operations include detecting hardware replacement events for a plurality of mass analysis instruments; detecting cleaning events for the plurality of mass analysis instruments; tracking instrument usage data for the plurality of mass analysis instruments; based on the instrument usage data and at least one of the hardware replacement events or the cleaning events, identifying high-performing mass analysis instruments; based on the instrument usage data of the high-performing mass analysis instruments, identifying a recommended setting; and performing at least one of: displaying the recommended setting on mass analysis instrument; or automatically implementing the recommended setting.

In another aspect, the technology relates to a system for improved mass analysis operation. The system includes a mass analysis instrument comprising a turbo pump; a processor; and memory storing instructions that, when executed by the processor, cause the system to perform a set of operations. The set of operations include accessing turbo pump machine-level characteristics; identifying a baseline for the turbo pump machine-level characteristics; receiving present turbo pump machine-level characteristics; based on a comparison of the present turbo pump machine-level characteristics and the identified baseline, determining an anomaly has occurred; receiving system operating conditions; based on the system operating conditions, determining that the anomaly is not expected; generating a failure indicator; and performing at least one of: activating an alarm based on the failure indicator; or shutting down the turbo pump based on the failure indicator.

In another aspect, the technology relates to a system for improved mass analysis operation. The system includes a mass analysis instrument comprising a hardware component; a processor; and memory storing instructions that, when executed by the processor, cause the system to perform a set of operations. The set of operations includes accessing machine-level characteristics for the hardware component; identifying a baseline for the machine-level characteristics for the hardware component; receiving present machine-level characteristics for the hardware component; based on a comparison of the present machine-level characteristics and the identified baseline, determining an anomaly has occurred; receiving system operating conditions; based on the system operating conditions, determining that the anomaly is not expected; generating a failure indicator; and performing at least one of: activating an alarm based on the failure indicator; or shutting down hardware component based on the failure indicator.

In another aspect, the technology relates to a method for operating a mass analysis instrument. The method includes receiving machine-level characteristics from the mass analysis instrument; evaluating the received machine-level characteristics based on at least one component criteria to identify a change in performance based on the evaluated component criteria; and when a change in performance is identified, transmitting a corrective action instruction.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1A depicts an example system for improving operations of mass analysis instruments.

FIG. 1B depicts another example system for improving operations of mass analysis instruments.

FIG. 1C depicts another example system for improving operations of mass analysis instruments.

FIG. 1D depicts another example system for improving operations of mass analysis instruments.

FIG. 2A depicts an example mass analysis instrument.

FIG. 2B depicts an example server.

FIG. 3A depicts an example method for proactively determining a contamination state or a degradation state of a mass analysis instrument.

FIG. 3B depicts another example method for proactively determining a contamination state or a degradation state of a mass analysis instrument.

FIG. 3C depicts another example method for proactively determining a contamination state or a degradation state of a mass analysis instrument.

FIG. 3D depicts another example for proactively determining a contamination state or a degradation state of a mass analysis instrument.

FIG. 4 depicts an example method for proactively determining a contamination state of a mass analysis instrument.

FIG. 5 depicts an example method for proactively determining a degradation state of one or more mass analysis instruments.

FIG. 6A depicts an example method for improving operation of one or more mass analysis instruments.

FIG. 6B depicts an example method for improving operation of one or more mass analysis instruments.

FIG. 7A depicts an example method for predicting a failure of a turbo pump.

FIG. 7B depicts an example plot of machine-level characteristics for a turbo pump.

### DETAILED DESCRIPTION

As discussed above, mass analysis instruments may become contaminated or have components that wear and potentially fail. The contamination or degradation of the components of the mass analysis instruments may cause the mass analysis instruments to operate at a reduced functionality. For instance, the accuracy or resolution of the results produced from the mass analysis instruments may be compromised. Mass analysis instruments are highly sensitive devices and, in many applications, accuracy is of paramount importance because inaccurate results may lead to false drug tests or inaccurate pharmaceutical tests. In the worst cases, degradation of components may cause the mass analysis instrument to cease to function all together. As an example of such a failure, when a turbo pump of a mass analysis instrument fails, the result can be catastrophic as the rotor may fragment and cause damage to other components, such as the ion optics components.

To help prevent such failures and contamination, the mass analysis instruments currently go through routine maintenance procedures that are performed on a regular basis. For instance, a mass analysis instrument may be cleaned and maintained every six months or every year. Such a routine schedule, however, fails to account for the actual state of a particular mass analysis instrument that is being maintained or cleaned. The particular mass analysis instrument may have been contaminated for several months prior to the cleaning, or components of the mass analysis instrument may have been significantly worn.

In some examples, the maintenance is only performed upon a failure occurring, which leads to downtime for the mass analysis instrument and potentially a shortage of replacement components, which causes even further delays in returning the mass analysis instrument to operation. On the other hand, if cleanings and maintenance are performed too frequently, the mass analysis instrument is unnecessarily removed from operation for the cleaning or maintenance and replacement components may be wasted.

Among other things, the present technology alleviates the above problems to improve the operation, longevity, and/or accuracy of the mass analysis instruments. Based on the particular operational characteristics of a mass analysis instrument, such as machine-level characteristics (e.g., voltages, temperatures, etc.) and mass analysis results (e.g., results from tests), the present technology is able to better determine the state of the mass analysis instrument and determine when cleanings and maintenance should occur. In some examples, the analysis is based off of history and usage of the mass analysis instrument itself. In other examples, the determinations may be bolstered through the use of comparative analytics from a plurality of mass analysis instruments. For instance, based on aggregated machine-level characteristics of a plurality of mass analysis instruments and mass analysis results from tests performed by those instruments, determinations regarding the state of a particular mass analysis instrument may be made.

Based on the determined state of a particular mass analysis instrument or mass analysis instruments, the cleaning and/or maintenance of the mass analysis instruments may be automatically scheduled, and the proper replacement components may be obtained for use in the maintenance and cleaning. In addition, based on the aggregated machine-level characteristics and mass analysis results, improved operating conditions and procedures for a particular mass analysis instrument may be recommended to improve performance and longevity of the mass analysis instrument. Accordingly, the operation of the mass analysis instrument is improved by proactively preventing the negative results associated with contamination and degradation of components without an unnecessary waste of resources.

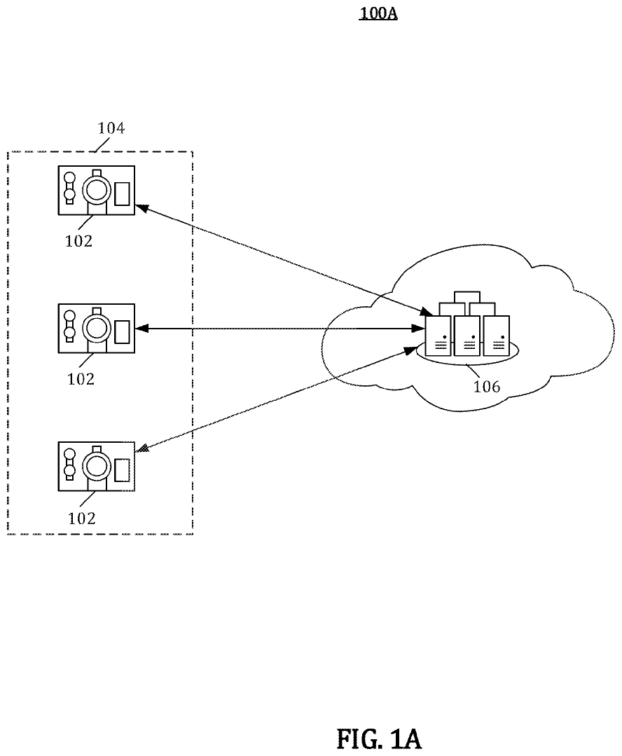

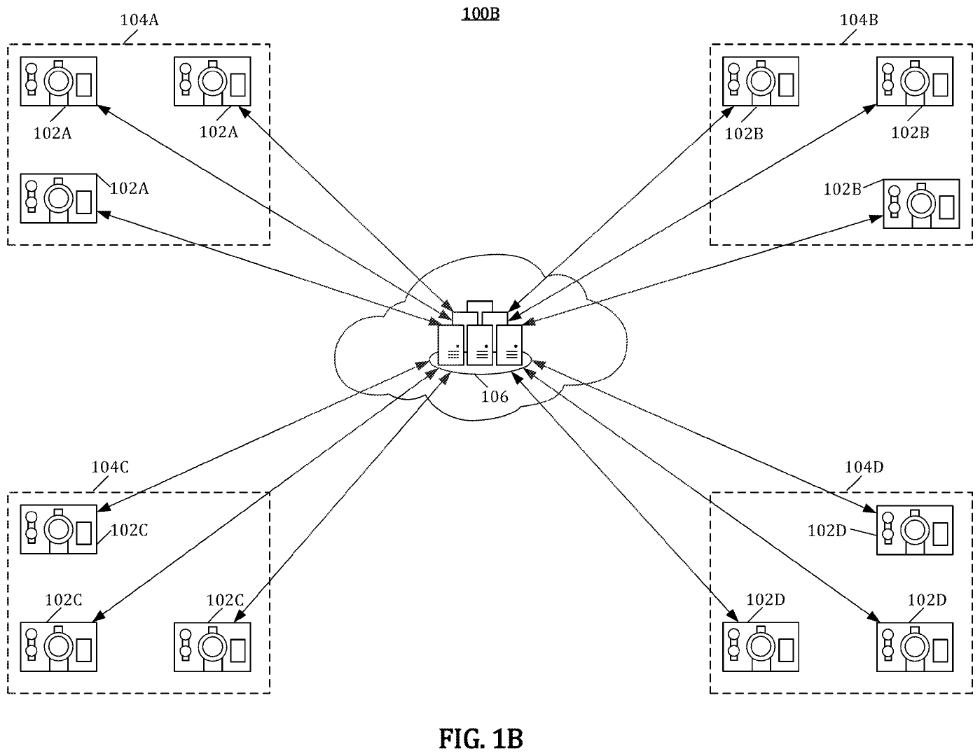

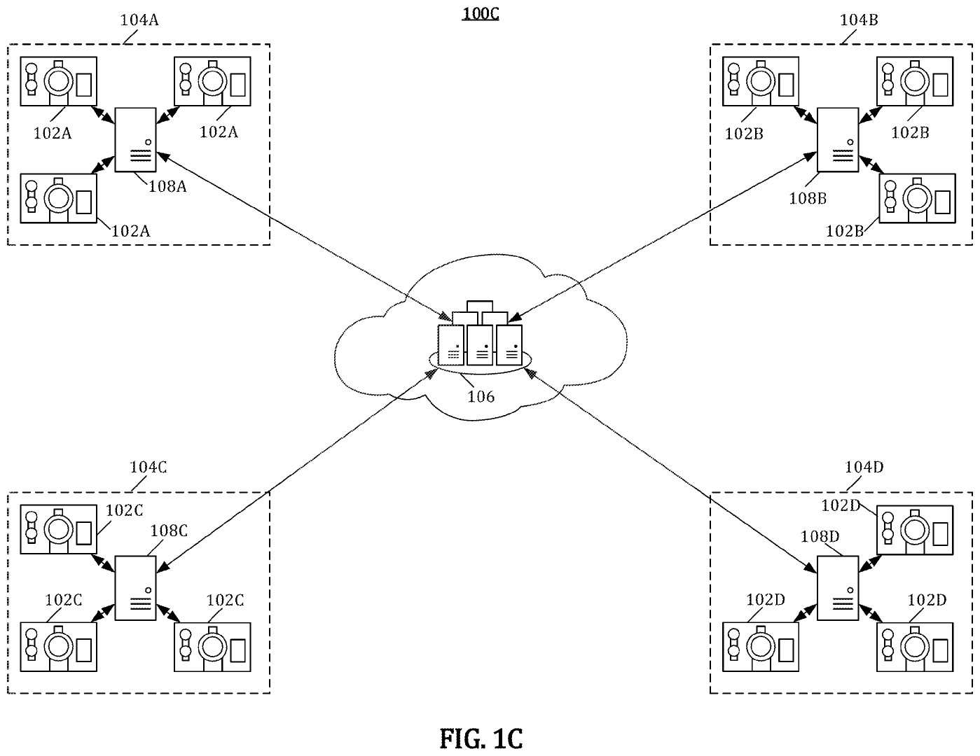

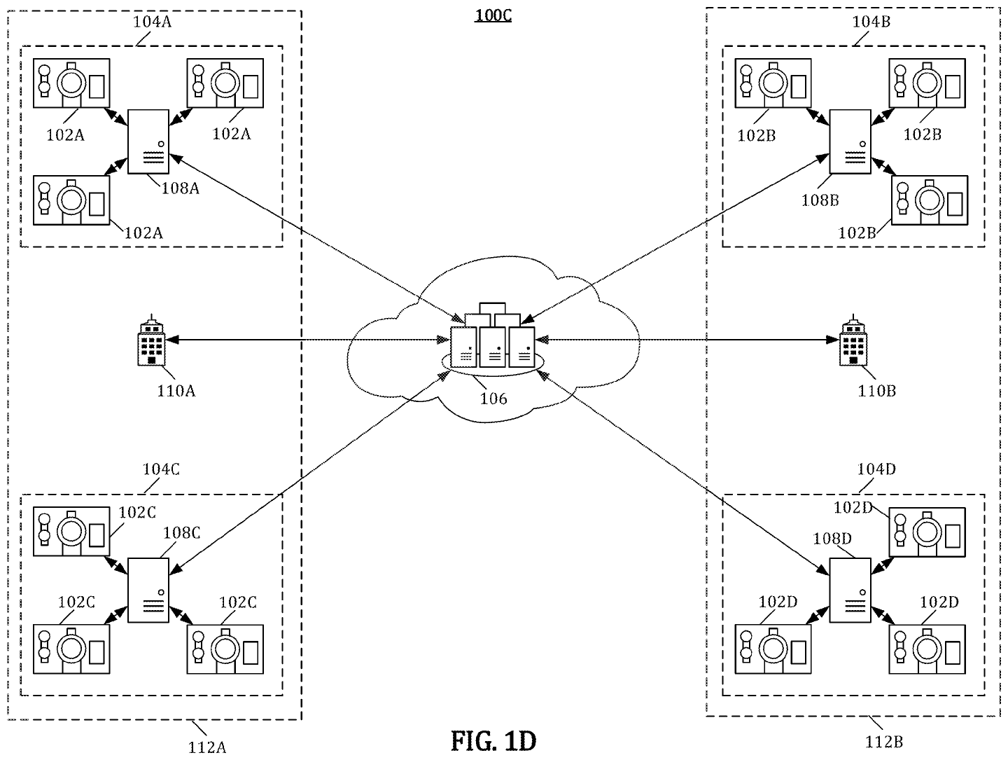

FIG. 1A depicts an example system 100A for improving operations of mass analysis instruments 102. The mass analysis instruments or instruments 102 may be housed in a particular facility 104, such as a laboratory, university, building, campus, or similar type of facility. Each of the mass analysis instruments 102 may include a mass spectrometer, a sample separator (e.g. including, but not limited to, a liquid chromatography device), and/or similar devices for analyzing the composition of an object. For instance, each of the mass analysis instruments 102 may include a stand-alone mass spectrometer, an on-line liquid chromatography-mass spectrometry (LC-MS), an on-line gas chromatography-mass spectrometry (GC-MS) system, a Fourier-transform ion cyclotron resonance mass spectrometer (FT-ICR-MS), or a tandem mass spectrometry system (MS-MS), among other types of mass analysis systems. While only three mass analysis instruments 102 are depicted as being in the facility 104, it should be appreciated that more or fewer mass analysis instruments 102 may be housed within the facility 104. For example, some facilities 104 may house hundreds of mass analysis instruments 102.

The mass analysis instruments 102 are configured to receive a sample and generate mass analysis results for the received sample. Testing of a sample generally requires multiple operations, including sample introduction, analyte ionization, mass analysis and ion detection, and data processing. Sample introduction may involve the mass analysis instrument 102 receiving an individual sample, multiple samples, and may also include chromatographic separation. During the analyte ionization operation, the sample or analyte from the sample introduction operation is ionized. For example, the mass analysis instrument 102 may produce gas phase ions that are suitable for use in the mass analysis and ion detection operations of the testing procedure. There are many different types of ionization techniques that can be used, such as electron ionization, chemical ionization, electrospray ionization, and matrix-assisted laser desorption ionization, among other techniques.

Once the ions are generated, the ions (having a mass m and z elementary charges e) are accelerated with a voltage V into an electric field E and/or a magnetic field B along a path with a radius of curvature r. The different ions having different mass to charge ratios (m z) can be distinguished by altering the electric field E, the magnetic field B, and/or the voltage V For example, by changing the electric field E, the magnetic field B, and/or the voltage V, the ions travel along a different radius of curvature r. Thus, depending on when and where an ion is detected by a detector of the mass analysis instrument 102, the mass-to-charge ratio of the ion can be determined. Different types of mass analyzers or mass filters may be used to accomplish the manipulation or acceleration of the ions to allow for such types of detection. Some examples include quadrupole mass analyzers, ion-trap mass analyzers, time-of-flight mass analyzers, and orbitrap mass analyzers, among others. These analyzers and techniques generally utilize a vacuum chamber, where the low pressure is generated via a vacuum pump system that often includes a rough pump and a turbo pump.

Detection of the ions may be performed through the use of various detectors or detection systems. Some example detection systems utilize an electron multiplier detector or a microchannel plate detector. Based on the signals from the detection system, mass analysis results may be generated. The mass analysis results may be in the form of mass spectra for the sample being analyzed. A mass spectrum may represent a set of ion counts for a particular amount of time. The mass analysis results may be generated in different formats or manners. For instance, the mass analysis results may be presented or stored as a total-ion chromatogram (TIC), an extracted-ion chromatogram (XIC), a base-peak chromatogram (BPC), or other types of formats.

During performance of the tests, the operation of the mass analysis instrument 102 may be described or characterized by its machine-level characteristics. The machine-level characteristics of the mass analysis instrument 102 include characteristics of operating conditions of the components of the mass analysis instrument 102. For instance, the machine-level characteristics may include temperatures, voltages, and/or currents of certain components of the mass analysis instrument 102. As an example, for the turbo pump, the machine-level characteristics may include at least the electrical current drawn by the turbo pump, the voltage applied to the turbo pump, the temperature of the turbo pump, the power consumed by the turbo pump, the vacuum pressure created by the turbo pump, and the frequency of the turbo pump (e.g., the rotations per minute of the turbo pump). Machine-level system component information may include, for instance, voltage, current, frequency, temperature, power, fluid flow rate, uptime, status, error code, polarity, and pressure as relevant for each of the system components. For instance, each pump may report a voltage, current, frequency, temperature, and/or pressure for that pump. The machine-level characteristics may be measured, recorded, or otherwise tracked on a continuous and/or interval basis. For instance, the machine-level characteristics may be recorded every 5-10 milliseconds (ms) or on the order of seconds, minutes, or other suitable time intervals. In addition or alternatively, a machine-level characteristic may be recorded upon a change in the respective machine-level characteristic. In the case of a commercial mass spectrometer, such as the SCIEX Triple Quad™ 7500 LC-MS/MS System available from AB SCIEX LLC of Framingham, MA. mass spectrometer, hundreds to thousands of machine-level characteristic variables may be tracked and/or recorded.

In the embodiment of system 100A, each of the mass analysis instruments 102 are in communication with a cloud-based server 106. The communication with the cloud-based server 106 may be achieved through many different communication techniques or protocols. The communication may be achieved through wireless connections, wired connections, and/or a combination of wired and wireless connections. For instance, the communication may be achieved through the Internet based on various Internet protocols (IP), such as the transmission control protocol (TCP), User Datagram Protocol (UDP), Internet Control Message Protocol (ICMP), Hypertext Transfer Protocol (HTTP), Post Office Protocol (POP), and/or File Transfer Protocol (FTP), and/or Internet Message Access Protocol (IMAP), among other types of communication protocols.

The mass analysis instruments 102 communicate their machine-level characteristics and/or mass analysis results to the cloud-based server 106. The mass analysis instruments 102 may transmit the data to the cloud-based server 106 when the data is generated, on a regular interval, and/or in response to a query from the cloud-based server 106. The cloud-based server 106 executes algorithms to perform operations on the received machine-level characteristics and/or mass analysis results to generate predictions and determinations about the mass analysis instruments 102 from which the data was received. For example, the cloud-based server 106 may determine a contamination state (e.g., a current state and/or a predicted future state) of a particular mass analysis instrument 102 and/or the degradation state (e.g., a current state and/or a predicted future state) of hardware components within the mass analysis instrument 102. Based on the contamination state and/or degradation state, the cloud-based server 106 may also automatically schedule cleanings or maintenance, and the cloud-based server 106 may also check inventory and order replacement components. The determinations and/or predictions made by the cloud-based server 106 may then be communicated back to the mass analysis instrument 102. The mass analysis instrument 102 may display indicators of the determined states and/or predictions.

In some examples, some or all of the operations based on the machine-level characteristics and mass-analysis results may be performed by the mass analysis instrument 102 itself rather than the cloud-based server 106. The cloud-based server 106 may include a single server or a plurality of servers that operate together to execute the algorithms and operations described herein. The cloud-based server 106 may be part of cloud-based computing platform or hosting platform, such as the Amazon Web Services (AWS) platform from Amazon.com, Inc. of Seattle, Washington, or the Azure platform available from Microsoft Corporation of Redmond, Washington.

FIG. 1B depicts another example system 100B for improving operations of mass analysis instruments 102A-D. System 100B differs from system 100A in FIG. 1A in that the system 100B includes a plurality of facilities 104A-D that each house a plurality of mass analysis instruments 102A-D. More specifically, system 100A includes a first facility 104A, a second facility 104B, a third facility 104C, and a fourth facility 104D. The first facility 104A includes a first plurality of mass analysis instruments 102A. The second facility 104B includes a second plurality of mass analysis instruments 102B. The third facility 104C includes a third plurality of mass analysis instruments 102C. The fourth facility 104D includes a fourth plurality of mass analysis instruments 102D.

Each of the plurality of mass analysis instruments 102A-D are in communication with the cloud-based server 106. The cloud-based server 106 operates in a similar manner as described above. For instance, for each of the mass analysis instruments 102A-D, the cloud-based server 106 may determine the state of the mass analysis instrument 102A-D. The determination of the state of a particular mass analysis instrument 102A-D may also be based on data collected from the other mass analysis instruments 102A-D. For example, determination regarding the state of a mass analysis instrument 102A in the first facility 104A may be based on patterns or trends of mass analysis instruments 102B-D in the other facilities 104B-D. It should be appreciated that while four different facilities 104A-D are depicted, more or fewer facilities may be in communication with the cloud-based server 106.

FIG. 1C depicts another example system 100C for improving operations of mass analysis instruments 102A-D. System 100C differs from system 100B depicted in FIG. 1B in that system 100C includes on-premises servers 108A-D. More specifically, in system 100C, each of the facilities 104A-D may include an on-premises server 108A-D. The plurality of mass analysis instruments 102A-D in each facility 104A-D may be in communication with each respective on-premises server 108A-D. For example, the mass analysis instruments 102A in the first facility 104A are in communication with the on-premises server 108A. Each of the on-premises servers 108A-D may then be in communication with the cloud-based server 106.

In system 100C, the on-premises servers 108A-D may perform one or more of the operations that the cloud-based server 106 performed in systems 100A-B. Accordingly, facilities 104A-D may have better control over the collection of data, and mass analysis results need not be exported off the facility 104A-D. In some examples, the on-premises servers 108A-D may transmit data to the cloud-based server 106 based on aggregated data from the mass analysis instruments 102A-D. For instance, the first on-premises server 108A may aggregate machine-level characteristics and mass analysis results from the first plurality of mass analysis instruments 102A, and the second on-premises server 108B may aggregate machine-level characteristics and mass analysis results from the second plurality of mass analysis instruments 102B. The on-premises server 108A may perform some operations based on the aggregated data and may also export the data to the cloud-based server 106 so that the cloud-based server 106 may perform additional operations. The mass analysis instruments 102A and/or the on-premises server 108A may anonymize or remove certain identifying information prior to sending the data to the cloud-based server 106 to help prevent sensitive information from being exported from the first facility 104A.

By incorporating multiple computing systems or devices (e.g., the mass analysis instrument 102A, the first on-premises server 108A, and the cloud-based server 106), additional computing power can be utilized when needed and sensitive data can also be protected. For instance, for simpler computing operations and/or for computing operations based on sensitive data, such computing operations may be performed directly on a mass analysis instrument 102A-D itself. More complicated computing operations that still require the operations to be based on sensitive data may be performed by a particular on-premises server 108A-D, which may have more computing power than an individual mass analysis instrument 102A-D. The most-intensive computing operations and/or computing operations that can be performed on anonymized data may then be performed by the cloud-based server 106. The cloud-based server 106 also has the additional benefit of having access to data received from multiple facilities 104A-D and thus multiple pluralities of mass analysis instruments 102A-D.

FIG. 1D depicts another example system 100D for improving operations of mass analysis instruments 102A-D. System 100D differs from system 100C depicted in FIG. 1C in that system 100D further includes service centers 110A-B and depicts regions 112A-B. Some facilities 104A-D may be closer in proximity than other facilities. For instance, the first facility 104A and the third facility 104C may be located in a first region 112A, and the second facility 104B and the third facility may be located in the second region 112B. Each region 112A-B may be a city, county, state, province, or type of region. Each region 112A-B may include one or more service centers 110A-B. The service centers 110A-B may store inventory of hardware components for the mass analysis instruments 102A-D housed in facilities 104A-D located within the particular regions 112A-B. The service centers 110A-B may also serve as a base location for maintenance or cleaning specialists that perform the cleaning and maintenance procedures. For example, the first service center 110A may store an inventory of components for the first plurality of mass analysis instruments 102A in the first facility 104A and the third plurality of mass analysis instruments 102C located in the third facility 104C.

In system 100D, the cloud-based server 106 is in communication with the service centers 110A-B. While not depicted, the on-premises servers 108A-D may also be in communication with the service centers 110A-B in their respective region 112A-B. The cloud-based server 106 and/or the on-premises servers 108A-D may then query the service centers 110A-B to determine availability of hardware components of mass analysis instruments 102A-D. For example, when the cloud-based server 106 determines that a degradation state of a component of mass analysis instrument 102A requires the component to be replaced soon, the cloud-based server 106 may query the service center 110A to determine if the component is in inventory. If the component is not in inventory, the cloud-based server 106 may automatically order the component and/or transmit a message to the service center 110A to cause the service center to order the component. Accordingly, inventory of components may be handled proactively to prevent unavailable or wasted components, particularly if the components have a limited shelf-life.

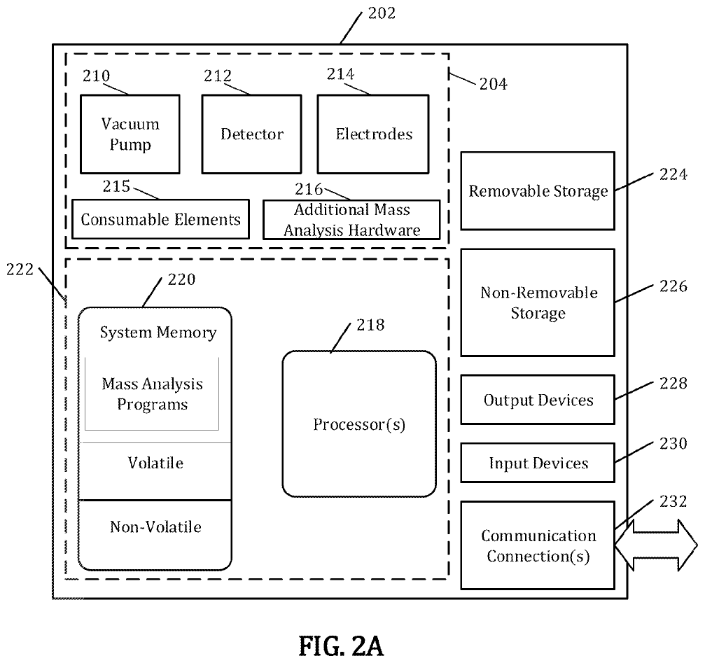

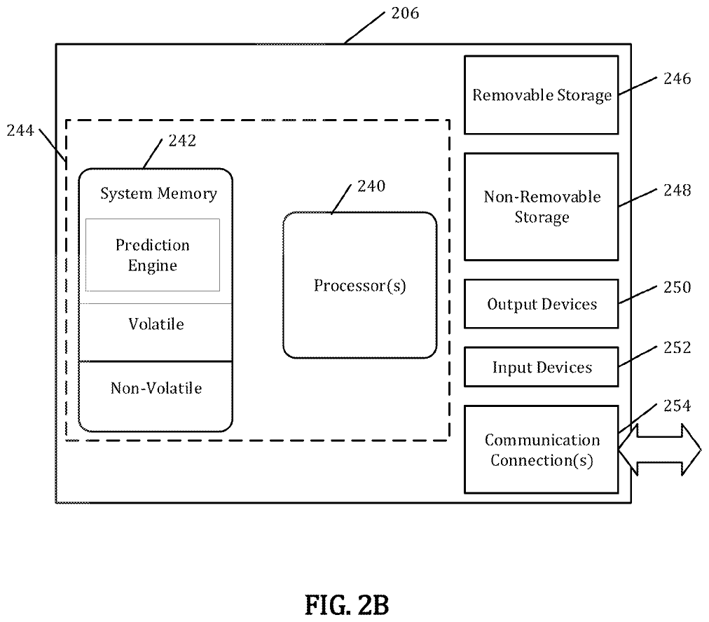

FIG. 2A depicts an example mass analysis instrument 202. The mass analysis instrument 202 includes mass analysis hardware and components 204. The mass analysis hardware and components 204 include various hardware and components that are specific to mass analysis instruments, such as a vacuum pump 210 (which may include a rough pump and a turbo pump), a detector 212, electrodes 214, consumable elements 215, and additional mass analysis hardware 216. The consumable elements 215 include items that have a limited lifetime and are intended to be replaced on a regular basis, such as heaters, detectors, pumps, filters, fluids (oil), electrodes, columns (for LC), gaskets, seals, etc. Under operation the mass analysis hardware consumes chemicals and other items in order to operate such as solvent, reagents, gas, etc. The additional mass analysis hardware 216 includes the remaining hardware that is necessary or utilized to carry out the mass analysis procedures, such as gas supply, pumps (e.g. roughing and turbo pumps), solvent supply pumps, physical chambers, separation components, high-voltage and low-voltage power supplies, heaters, valves, ion sources, wires, connectors, fasteners, fittings, specialized electronics, etc.

The mass analysis instrument 202 may also include computing components 222. The computing components 222 may be housed within the mass analysis instrument 202 itself, located adjacent to the mass analysis instrument 202, or be in electronic communication with the mass analysis hardware and components 204. In its most basic configuration, the computing components 222 typically include at least one processor 218 and memory 220. Depending on the exact configuration, memory 220 (storing, among other things, mass analysis programs and instructions to perform the operations disclosed herein) can be volatile (such as RAM), non-volatile (such as ROM, flash memory, etc.), or some combination of the two. Further, the mass analysis instrument 202 may also include storage devices (removable, 224, and/or non-removable, 226) including, but not limited to, solid-state devices, magnetic or optical disks, or tape. Further, mass analysis instrument 202 may also have input device(s) 230 such as touch screens, keyboard, mouse, pen, voice input, etc., and/or output device(s) 228 such as a display, speakers, printer, etc. One or more communication connections 232, such as local-area network (LAN), wide-area network (WAN), point-to-point, Bluetooth, RF, etc., may also be incorporated into the mass analysis instrument 202.

FIG. 2B depicts an example server 206, which may be a cloud-based server or an on-premises server. The example server 206 may include many of the same type of components as the mass analysis instrument 202. For instance, the server 206 may include computing components 244. The computing components 244 include at least one processor 240 and memory 242. Depending on the exact configuration, memory 220 (storing, among other things, a prediction engine and instructions to perform the operations disclosed herein) can be volatile (such as RAM), non-volatile (such as ROM, flash memory, etc.), or some combination of the two. Further, the server 206 may also include storage devices (removable, 246, and/or non-removable, 248) including, but not limited to, solid-state devices, magnetic or optical disks, or tape. Further, the server 206 may also have input device(s) 252 such as touch screens, keyboard, mouse, pen, voice input, etc., and/or output device(s) 250 such as a display, speakers, printer, etc. One or more communication connections 252, such as local-area network (LAN), wide-area network (WAN), point-to-point, Bluetooth, RF, etc., may also be incorporated into the server 206.

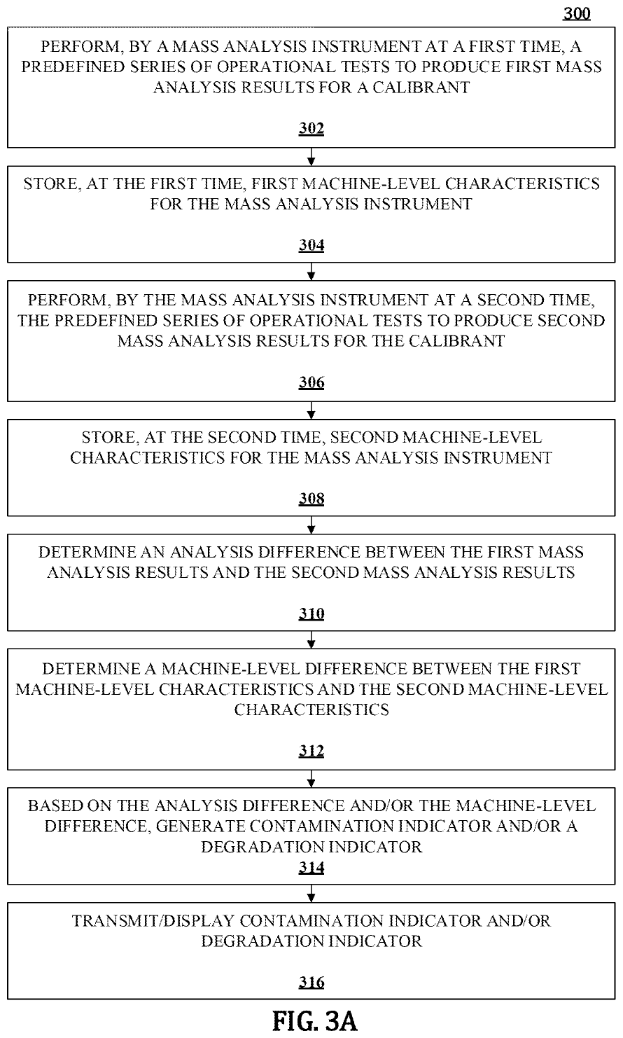

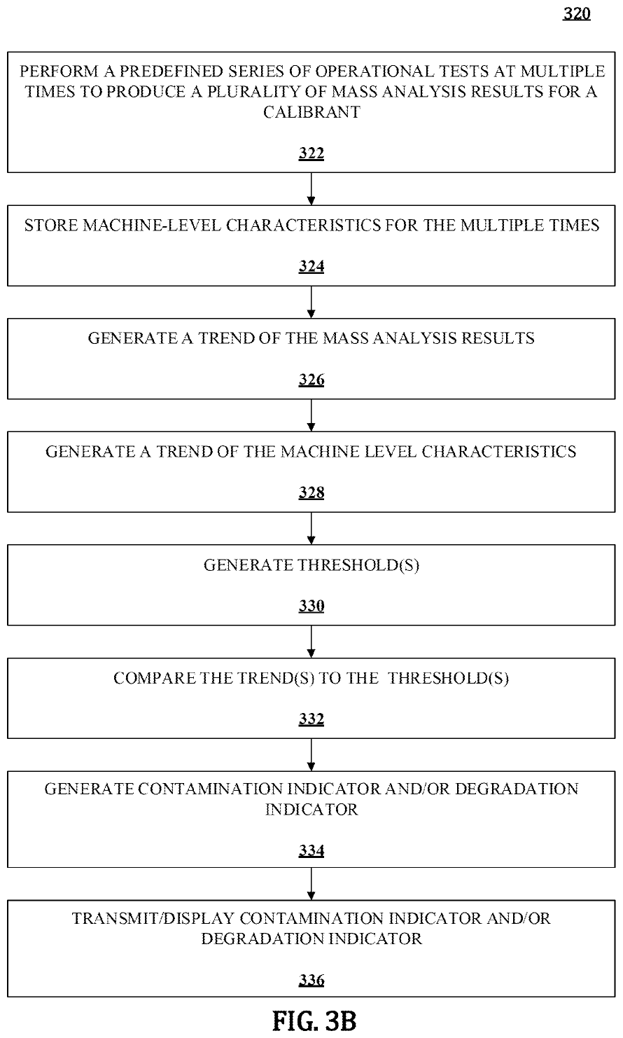

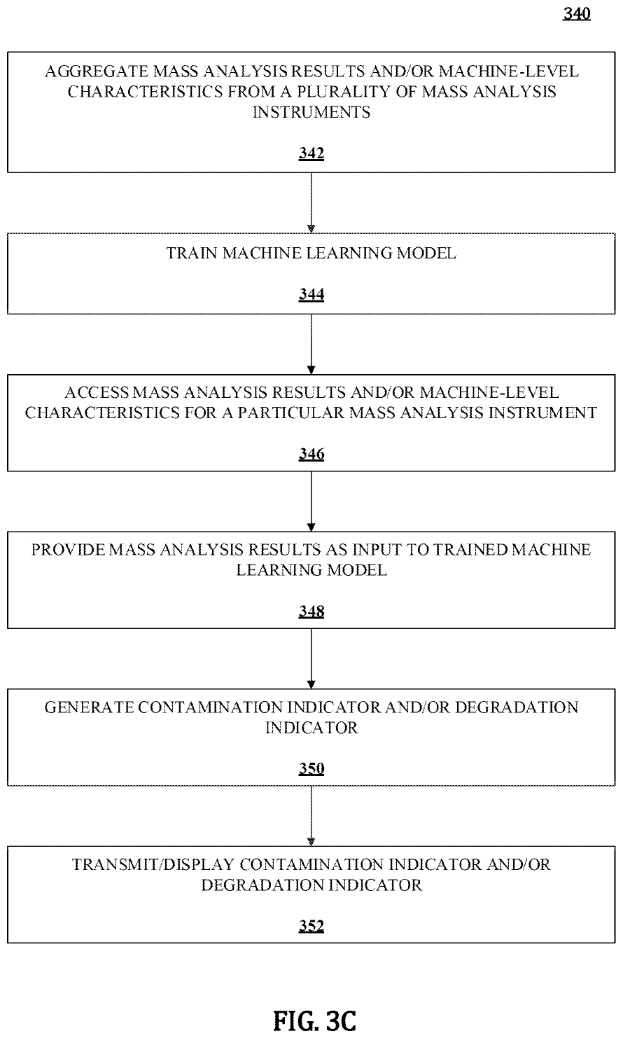

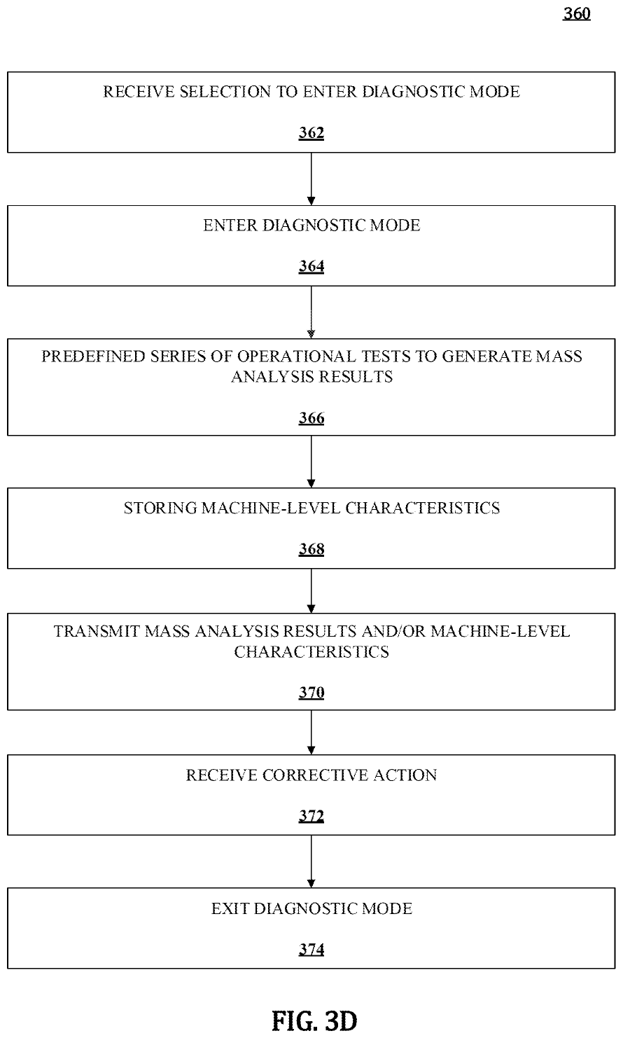

FIG. 3A depicts an example method 300 for proactively determining a contamination state or a degradation state of a mass analysis instrument. At operation 302, a predefined series of operational tests are performed by a mass analysis instrument at a first time. The first time may be a particular date. The series of operational tests may be performed to analyze a calibrant, which is a particular type of sample for which particular results are expected. The series of operational tests may be performed to produce first mass analysis results (e.g., mass spectra) for the calibrant. The predefined series of operational tests may be tests that can be repeated at a later time. For instance, the predefined series of operational tests are performed on a defined calibrant, which has defined characteristics, such as purity or concentration. Instructions for performing the series of operational tests may be stored in memory of the mass analysis instrument.

The series of operational tests may be performed automatically upon the mass analysis instrument receiving the calibrant as a sample for analysis. For instance, when the calibrant is inserted into the mass analysis instrument, the mass analysis instrument may automatically detect that the received sample is a calibrant. This automatic detection may occur based on a barcode or other indicia on the calibrant that indicates that it is a calibrant. Based on receiving the calibrant or upon detection of the calibrant, the mass analysis instrument automatically performs the series of operational tests.

In other examples, the series of operational tests are performed in response to a calibration setting or input being selected or received. For example, a selection for the mass analysis instrument to enter a diagnostic mode may be received by the mass analysis instrument. The mass analysis instrument may then enter the diagnostic mode to perform the predefined series of operational tests. In some examples, the mass analysis instrument may automatically enter the diagnostic mode at a scheduled time on a regular interval. The scheduled time may be a time when the mass analysis instrument is less likely to be needed, such as at night in some facilities. In such cases, a calibrant may be stored in the mass analysis instrument such that it may be tested in the predefined series of operational tests. While the mass analysis instrument is in the diagnostic mode (e.g., performing the predefined series of operational tests), the mass analysis instrument may establish a connection (e.g., internet access) to a server to communicate the results the operational tests. The connection may be terminated once the operational tests are completed and the diagnostic mode ends. Accordingly, the mass analysis instrument may be isolated from the server unless the mass analysis instrument is in the diagnostic mode, providing for additional security when other samples are being tested.

The predefined series of operational tests may include a variety of tests that may be used to generate mass analysis results that can be compared to the expected results for the calibrant. For example, the operational tests may include a polarity test, a ramping test, a detector optimization test, an ion spray voltage optimization test, and/or a transfer optics voltage optimization test. In a polarity test, the polarity of the electric field may be switched. For instance, the mass analysis instrument is operated in a positive ion mode for a first duration (e.g., 15 minutes), and mass analysis results (e.g., peak width, intensity, and signal stability) are generated. The mass analysis instrument is then switched to a negative ion mode for a second duration (e.g., 5 minutes), and then the mass analysis instrument is switched back to the positive ion mode for a third duration (e.g., 15 minutes) and mass analysis results (e.g., peak width, intensity, and signal stability) are again generated. If the mass analysis results generated during the first duration differ from the mass analysis results from the third duration by more than a threshold (e.g., 10%), then the mass analysis instrument is likely contaminated. In an example ramping test, the magnitude of the electric field may be ramped up or down. For instance, the voltage may be increased from −20V to 20V in set intervals (e.g., 0.1V). A determination is made as to which interval the highest peak intensity occurs. If the highest peak intensity occurs at the expected voltage (e.g., −10V), then the mass analysis instrument may be considered operational or non-contaminated. If the highest peak intensity occurs a threshold away from the expected voltage, the mass analysis instrument may be contaminated.

In some examples, the mass analysis results may be analyzed to determine if they fall within a threshold or tolerance level of the expected results. If the mass analysis results fall within the threshold or tolerance level of the expected results, the mass analysis instrument may be deemed to be calibrated or operating in normal condition. If the mass analysis results fall outside the threshold, the mass analysis instrument may be deemed to be operating in an abnormal condition and require cleaning, maintenance, or an adjustment to machine-level characteristics.

At operation 304, at the same time as the series of operational tests are being performed (e.g., the first time), first machine-level characteristics are stored for the mass analysis instrument. For example, while the predefined series of operational tests are being performed, the machine-level characteristics for the mass analysis instrument (e.g., voltage, temperature, current, etc.) may be recorded and stored. The machine-level characteristics may be recorded throughout the performance of the operational tests such that a time series of machine-level characteristics are stored.

At operation 306, the mass analysis instrument performs the predefined set of operational tests for the calibrant at a second time to produce second mass analysis results for the calibrant. The second time may be a date after the first time, such as a number of days, weeks, or months after the first time. For instance, the second time may be at least one week after the first time. The predefined set of operational tests performed at the second time are the same predefined set of operational tests performed at the first time, and the operational tests are performed on the same calibrant (e.g., a calibrant having the same purity, concentration, etc. as the calibrant utilized at the first time). At operation 308, at the same time as the operational tests are being performed again (e.g., the second time), second machine-level characteristics for the mass analysis instrument are stored. The second machine-level characteristics may be the machine-level characteristics of the mass analysis instrument while the predefined set of operational tests are being performed at the second time.

At operation 310, an analysis difference between the first mass analysis results produced in operation 302 and the second mass analysis results produced in operation 308 is determined. The analysis difference may be a difference between features of the mass spectra of the first mass analysis results and the second mass analysis results. For example, the analysis difference may include a difference between peak heights, peak locations, peak widths, etc. To determine the analysis difference, the mass analysis instrument and/or server may access the first mass analysis results produced from the mass analysis instrument at the first time and the second mass analysis results produced from the mass analysis instrument at the second time.

The analysis difference allows for comparison of mass analysis instrument performance over time and the detection of necessary service conditions, such as due to contamination and/or degradation of components. Accordingly, the analysis difference indicates a change in the mass analysis results between the times at which the predefined series of operational tests are performed. Thus, the analysis difference may be referred to as an analysis change. In some aspects, the analysis difference may be used to project a future date/time when instrument performance may drop below a threshold level. In the case of contamination, instrument performance from test to test may degrade. The magnitude or difference in performance between the test dates may be used to extrapolate and identify an expected future time when the instrument performance will fail to meet the threshold. In the case of degradation, the magnitude or difference in performance between the test dates may be used to confirm that the components are operating within specification, or are starting to show degradation. Generally, contamination should result in a steady decline in instrument performance over time, assuming consistent use. Component degradation may show no decline in performance for a long period of time, and then performance may change as component operation suffers due to degradation. In some aspects, component degradation may be modelled based on measured use of the instrument, in order to provide a prediction on future life.

Peak height, width, location, etc. may all be important factors to indicate changes in instrument performance. Since identifying a cause of any change may be complicated, a service call may be required for a technician to apply subjective analysis to identify a specific possible cause or to iterate through possible causes to bring the instrument back to an expected performance level.

Instrument stability is an important characteristic that is currently difficult to track. In particular, there are two types of stability that are important. In the short term, noise may be introduced into the analysis results causing immediate changes. This is often indicative of specific changes, such as component failure, contamination, or other environmental change. Over the long term, the signal should be stable, and slower long-term changes in signal (e.g., drift) may be difficult for a user to detect. Long term signal stability may vary on a number of factors, but typically slower acting issues such as contamination or gradual component degradation may be associated with long term stability changes.

At operation 312, a machine-level difference between the first machine-level characteristics stored in operation 304 and the second machine-level characteristics stored in operation 308 is determined. Accordingly, the machine-level difference indicates a change in the machine-level characteristics between the times at which the predefined series of operational tests are performed. Thus, the machine-level difference may be referred to as the machine-level change. The machine-level difference may include differences between data such as voltages, currents, temperatures, or other machine-level characteristics. The machine-level difference may also include differences between rates of change (e.g., slope or first derivative) or acceleration (e.g., second derivative) of the machine-level characteristics during the performance of the operational tests. Thus, as an example, a difference in how quickly a voltage ramps up during a particular operational test may be determined. To determine the analysis difference, the mass analysis instrument and/or server may access the first machine-level characteristics stored by the mass analysis instrument at the first time and the second machine-level characteristics stored by the mass analysis instrument at the second time.

At operation 314, a contamination indicator and/or a degradation indicator are generated based on the analysis difference determined in operation 310 and/or the machine-level difference determined in operation 312. In some aspects, the contamination indicator and/or degradation indicator may be based on a change in the mass analysis results collected at different times. For instance, the change may be based on a trend in the mass analysis results and/or the machine-level characteristics, or a magnitude and/or sign (e.g., positive or negative) of the analysis difference and/or the machine-level difference.

The contamination indicator may indicate current state of contamination as well as a predicted future state of contamination. The state of contamination may be represented on a scale, such as 0-10 or low-medium-high. Thus, in such examples, the level of contamination may be indicated by the contamination indicator. A contamination threshold level may be selected or assigned. Once the level of contamination reaches the contamination threshold, the mass analysis instrument should be cleaned. In other examples, the state of contamination may be binary, such as contaminated or not contaminated. Based on the analysis difference and/or the machine-level difference, a prediction of a future contamination state may also be made. For example, where the magnitude of the analysis difference and/or machine-level difference is high (indicating a rapid rate of change between the first time and the second time), the mass analysis instrument may be becoming contaminated more quickly. The contamination prediction may provide predictions for the contamination state at one or more points in the future or may provide only a prediction for a date at which the contamination state is predicted to exceed the contamination threshold, at which point the mass analysis instrument should be cleaned. By having a prediction of contamination state based on a trend in machine-level characteristics and/or mass analysis results for a specific mass analysis instrument, cleanings of the mass analysis instrument may be proactively completed to prevent the negative effects of contamination. Further, cleanings are not performed when they are not needed, which conserves resources and does not require the mass analysis instrument to be taken unnecessarily offline.

The degradation indicator may indicate current state of contamination as well as a predicted state of degradation for a particular component or components. The state of degradation may be represented on a scale, such as 0-10 or low-medium-high. Thus, in such examples, the level of degradation may be indicated by the degradation indicator. A degradation threshold level may be selected or assigned for one or more components. Once the level of degradation reaches the degradation threshold, the component should be maintained or replaced. In other examples, the state of degradation may be binary, such as degraded or not degraded. Based on the analysis difference and/or the machine-level difference, a prediction of a degradation state may also be made. For example, where the magnitude of the analysis difference and/or machine-level difference is high (indicating a rapid rate of change between the first time and the second time), the components of the mass analysis instrument may be degrading more quickly. The degradation prediction may provide predictions for the degradation state at one or more points in the future or may provide only a prediction for a date at which the degradation state for a component is predicted to exceed the degradation threshold, at which point the component should be maintained or replaced. By having a prediction of degradation state based on a trend in machine-level characteristics and/or mass analysis results for a specific mass analysis instrument, maintenance of the mass analysis instrument may be proactively completed to prevent the negative effects of degrading components. Further, maintenance is not performed when it is not needed and parts are not unnecessarily replaced, which converses resources and increases uptime of the mass analysis instrument.

As one specific example, the first mass analysis results may have a particular peak that has a peak width (typically determined at full width half maximum (FWHM)), which is the expected peak width for the example calibrant being tested. Ten days later, second mass analysis results are produced, and in the second mass analysis results, the peak width (at FWHM) may be wider than the first peak width. Thus, there has been a degradation in resolution between the time the first mass analysis results were acquired and the time the second mass analysis results were acquired. Based on the difference between peak width in the second mass analysis results and the peak width in the first mass analysis results, the mass analysis instrument may be predicted to likely have a peak width at or exceeding the threshold at a future date after the second mass analysis results were acquired. The future date may be determined, for instance, by extrapolating from a trend identified by a change in the peak width between the first mass analysis test date and the second mass analysis test date. Thus, if peak width degradation (e.g., resolution degradation) is associated with contamination for the particular operational test that was performed to produce the mass analysis results, then cleaning of the mass analysis instrument should occur at a future date when the trend indicates the instrument will likely have degraded to a threshold point. If the peak width degradation is associated with a degraded component of the mass analysis instrument for the particular test, then that component should be replaced or serviced within that period.

At operation 316, the contamination indicator and/or degradation indicator generated in operation 314 are transmitted and/or displayed. For example, if the contamination indicator and/or degradation indicator are generated by a server, the contamination indicator and/or degradation indicator may be transmitted to the mass analysis instrument. The mass analysis instrument may then display the contamination indicator and/or degradation indicator. The contamination indicator and/or degradation indicator may also be displayed on web-based dashboard via a computing device that is in communication with the server. For example, the computing device may access the web-based dashboard through an application or web browser. The contamination indicator and/or degradation indicator may also be transmitted via an electronic message, such as an e-mail or other message.

Displaying the degradation indicator may include displaying a determined degradation state or level of a hardware component of the mass analysis instrument, the predicted degradation state or level for the hardware component, and/or the predicted date by which the hardware component should be replaced or maintained, among other types of information and display formats. Displaying the contamination indicator may include displaying a determined contamination state or level of the mass analysis instrument, the predicted contamination state or level, and/or the predicted date by which a cleaning should be completed based on the predicted contamination state, among other types of information and display formats.

In addition, in some examples, a cleaning or maintenance procedure may be automatically scheduled based on the current contamination state, the predicted contamination state, the current degradation state, and/or the predicted degradation state. The cleaning or maintenance maybe automatically scheduled by sending an electronic message to a service center in the region of the mass analysis instrument that is to be maintained or cleaned.

While method 300 depicts performing the predefined set of operational tests at only two times, the predefined set of operational tests may be performed more than twice, and the mass analysis results and/or machine-level characteristics from each of the tests (and/or the differences therebetween) may be used in generating the contamination indicator and/or the degradation indicator. For instance, the mass analysis instrument may perform the predefined series of operational tests at the three or more different times (e.g., a first time, a second time, and a third time), to produce first mass analysis results, second mass analysis results, and third mass analysis results for the calibrant. Machine-level characteristics may also be stored at the first, second, and third times. A first analysis difference between the first mass analysis results and the second mass analysis results may be determined, and a second analysis difference between the second mass analysis results and the third mass analysis results may be determined. The first analysis difference indicates a rate of change in mass analysis results from the first time to the second time, and the second analysis difference indicates a rate of change in mass analysis results from the second time to the third time. A third analysis difference between the first analysis difference and the second analysis difference may also be determined. The third analysis difference may be indicative of how the rates of change are changing (e.g., the acceleration) of the mass analysis results. As such, the third analysis difference, may indicate if the mass analysis results are changing more quickly, which may inform when the mass analysis instrument is likely to become contaminated or degraded. Similar machine-level differences may also be determined. Based on the magnitude and/or sign of the differences, such as the third analysis difference or a similar machine-level difference, a contamination indicator and/or a degradation indicator may be generated.

The method 300 provides a customized determination of contamination state and/or degradation state for the particular mass analysis instrument. Because different types of samples may be tested and different types of sample preparation may be applied for each different mass analysis instrument, there is a significant benefit to customizing the state determinations to the particular mass analysis instrument. As an example, two different mass analysis instruments may perform a series of tests that are very similar, but the samples on which the tests were performed were substantially different or prepared in a substantially different manner. For instance, in a first mass analysis instrument, a sample of urine may be prepared by diluting the urine and directly analyzing the diluted urine. In a second mass analysis instrument, a sample of urine may first be processed by removing salts from the urine through an LC tube and then analyzing the de-salted urine. In this example, the first mass analysis instrument may become contaminated much more quickly than the second mass analysis instrument despite the two mass analysis instruments performing the same types of tests on the same types of samples. Thus, generating a contamination indicator that is specific to each of the mass analysis instruments is beneficial and provides a more accurate measurement or representation of the state of each of the mass analysis instruments.

FIG. 3B depicts another method 320 for proactively determining a contamination state or a degradation state of a mass analysis instrument. At operation 322, a predefined series of operational tests are performed at multiple times (e.g., a first time, second time, third time, etc.) to a produce a plurality of mass analysis results for a calibrant. The predefined set of operational tests may be the same type of operational tests described above. At operation 324, machine-level characteristics for the mass analysis instrument may be stored for the multiple times at which the predefined series of operational tests were performed.

At operation 326, a trend of the plurality of mass analysis results is generated. The trend of mass analysis results may be a rate of change of the mass analysis results and/or an acceleration of the mass analysis results, among other things. The trend may be generated by fitting a curve to the plurality of mass analysis results. In other examples, the trend may be determined by calculating differences between the individual mass analysis results acquired at the different times.

At operation 328, a trend of the machine-level characteristics is generated. The trend of the machine-level characteristics may be a rate of change of the machine-level characteristics and/or an acceleration of the machine-level characteristics, among other things. The trend may be generated by fitting a curve to the machine-level characteristics. In other examples, the trend may be determined by calculating differences between the individual machine-level characteristics stored at the different times.

At operation 330, one or more thresholds are generated. An analysis threshold may be generated for the trend of the mass analysis results and a machine-level threshold may be generated for the trend of the machine-level characteristics. The analysis threshold and/or the machine-level threshold may be based on predefined thresholds for the calibrant tested, such as the peak heights, locations, widths, etc. In other examples, the analysis threshold and/or the machine-level threshold may be based on prior performance of the mass analysis instrument itself. For instance, the predefined series of operational tests may be performed at a time where it is known that the mass analysis instrument is not contaminated and not degraded, and the mass analysis results and/or machine-level characteristics may be considered target or ideal conditions. The analysis threshold and/or the machine-level threshold may then be based on those target or ideal conditions. For instance, the thresholds may be a percentage or certain value of the ideal conditions. The analysis threshold and/or the machine-level threshold may also be based on the mass analysis results and/or machine-level characteristics that occurred prior to previous cleanings or maintenance. For example, the mass analysis results and/or machine-level characteristics that were produced from performing the operational tests prior to the cleaning or maintenance may be used as the analysis threshold and/or the machine-level threshold.

The analysis threshold and/or the machine-level threshold may also be based on aggregated data from a plurality of mass analysis instruments, such as multiple mass analysis instruments from the same facility or mass analysis instruments in different facilities. The mass analysis instruments from which the data is aggregated may be similarly situated mass analysis instruments, such as mass analysis instruments having similar operating conditions, being located in the same region, or having similar usage or usage types, among other similarities. For example, the mass analysis results produced from the plurality of mass analysis instruments performing predefined series of operational tests on the calibrant may be aggregated by a device, such as the cloud-based server or the on-premises server. The corresponding machine-level characteristics may also be aggregated. Based on the aggregated mass analysis results and/or machine-level characteristics, the analysis threshold and/or the machine-level threshold may be generated. For instance, if cleanings or maintenance are generally performed following certain mass analysis results and/or machine-level characteristics across the plurality of mass analysis instruments, those mass analysis results and/or machine-level characteristics may be used as the analysis threshold and/or the machine-level threshold. As an example, the analysis threshold and/or the machine-level threshold may be based on the average mass analysis results and/or machine-level characteristics that occurred most-recently prior to a cleaning or maintenance across the plurality of mass analysis instruments.

At operation 332, the trend of the mass analysis results and/or the trend of the machine-level characteristics may be compared to the analysis threshold and/or the machine-level threshold generated in operation 330. For instance, a rate of change of the mass analysis results and/or the machine-level characteristics may be compared to the corresponding thresholds to determine when the mass analysis results and/or machine-level characteristics may reach the corresponding thresholds. At operation 334, based on a comparison of the trend(s) to the threshold(s), a contamination indicator and/or a degradation indicator are generated. The contamination indicator and/or degradation indicator may include the same or similar information as discussed above. For example, the contamination indicator may include a current indication of the contamination state of the mass analysis instrument and a future indication of the contamination state of the mass analysis instrument. At operation 336, the contamination indicator and/or degradation indicator generated in operation 334 are transmitted and/or displayed, which may be performed as discussed above.

FIG. 3C depicts another method 340 for proactively determining a contamination state or a degradation state of a mass analysis instrument. At operation 342, mass analysis results and/or machine-level characteristics that have been produced or stored by a plurality of mass analysis instruments are aggregated. The aggregated mass analysis results may be mass analysis results that were generated from performing the predefined series of operational tests on the calibrant, and the aggregated machine-level characteristics may be the corresponding machine-level characteristics stored during performance of the operational tests. The plurality of mass analysis instruments may include mass analysis instruments from a particular facility or mass analysis instruments from a plurality of facilities. The aggregation may be performed by cloud-based server and/or an on-premises server. Times of cleaning and/or maintenance for the plurality of mass analysis instruments may also be aggregated in operation 342.

At operation 344, a machine learning model is trained based on the data aggregated in operation 344. The machine learning model may include a variety of different machine learning models, such a neural networks, Markov models, support vector machines, decision trees, K-nearest neighbors, Naive Bayesian models, K-means, random forests, and the like. The training may be based on an unsupervised learning algorithm or a supervised learning algorithm. In the supervised algorithm, the aggregated data may be labeled prior to training the machine learning model. For example, the aggregated data may be labeled according to the time at which a cleaning or maintenance was performed. For instance, the machine analysis results that were performed most recently prior to the cleaning may be labeled as such. The other results may also be labeled based on the temporal proximity to the cleaning or maintenance procedure. Once the machine learning model has been trained, the trained machine learning model may be stored for future use.

At operation 346, the mass analysis results and/or machine-level characteristics for a particular mass analysis instrument are accessed, received, or produced. For instance, a server may access or receive the data, and the particular mass analysis instrument may produce the data. The mass analysis results may be mass analysis results that were generated from performing the predefined series of operational tests on the calibrant at multiple times by the particular mass analysis instrument, and the machine-level characteristics may be the corresponding machine-level characteristics stored during performance of the operational tests by the particular mass analysis instrument.

At operation 348, the mass analysis results and/or machine-level characteristics that were accessed, received, or produced at operation 346 are provided as input into the trained machine learning model that was trained in operation 344. The trained machine learning model processes the data and provides an output. At operation 350, based on the output of the trained machine learning model, a contamination indicator and/or degradation indicator are generated. The contamination indicator and/or degradation indicator may include the same or similar information or data as described above. At operation 352, the contamination indicator and/or degradation indicator generated in operation 350 are transmitted and/or displayed, which may be performed as discussed above.

FIG. 3D depicts another method 360 for proactively determining a contamination state or a degradation state of a mass analysis instrument. At operation 362, a mass analysis instrument receives a selection or indication to enter a diagnostic mode. The selection or indication may be received via a selection of a diagnostic mode option on the mass analysis instrument, such as through a user interface or button of the mass analysis instrument. In some examples, the indication may also be received from a server or may be automatically generated locally based on a schedule. The scheduled time may be a time when the mass analysis instrument is less likely to be needed, such as at night in some facilities. Receipt of the selection or indication may cause the mass analysis instrument to display a prompt to confirm that the diagnostic mode should be entered.

At operation 364, the mass analysis instrument enters the diagnostic mode. Entering the diagnostic mode may be based on receiving the indication and/or selection in operation 364 or a confirmation to enter the diagnostic mode. Entering the diagnostic mode may include accessing instructions to perform the predefined series of operational tests for a diagnostic procedure of the mass analysis instrument. A connection between the mass analysis instrument and a server may also be established upon entering the diagnostic mode. Upon entering a diagnostic mode, the mass analysis instrument may display a prompt to insert the calibrant that is to be tested. The prompt may be displayed on a user interface of the mass analysis instrument. The calibrant then may be received by the mass analysis instrument. In other examples, the mass analysis instrument may store multiple samples of the calibrant that can be automatically accessed by the mass analysis instrument upon entering the diagnostic mode.

At operation 366, the predefined series of operational tests are performed on the calibrant to generate mass analysis results. At operation 368, the machine-level characteristics for the components of the mass analysis instrument during the operational tests are stored. At operation 370, the mass analysis results and/or the machine-level characteristics may be transmitted to a server. The server may analyze the transmitted mass analysis results and/or the machine-level characteristics to determine whether there has been a change in the mass analysis results and/or the machine-level characteristics from prior diagnostic procedure of the mass analysis instrument. For instance, the machine-level characteristics may be evaluated or analyzed based on component criteria to identify a change in performance of the mass analysis instrument. The component criteria may be a set of thresholds for change or other criteria for evaluating an effect of change in machine-level characteristics on performance of the mass analysis instrument. Based on the evaluation of the machine-level characteristics and/or the mass analysis results and the change thereof, the server may generate a corrective action instruction.

The corrective action instruction may include an instruction to schedule a maintenance call or cleaning of the mass analysis instrument. In such examples, the corrective action instruction may be transmitted to a scheduler system to schedule the maintenance call or cleaning. Other corrective action instructions may be instructions for the mass analysis instrument to perform. For example, the corrective action instruction may be an instruction directing the mass analysis instrument to display an indicator related to the identified change in performance of the mass analysis instrument. In another example, the correction action instruction directs the mass analysis instrument to power down. In the examples where the corrective action instruction is for the mass analysis instrument, the corrective action instruction is sent from the server to the mass analysis instrument, and the corrective action instruction is received by the mass analysis instrument at operation 372. The mass analysis instrument may then perform the corrective action in the corrective action instruction. In some examples, the evaluation of the machine-level characteristics and/or the mass analysis results, and generation of the corrective action instructions may be performed by the mass analysis instrument itself.

At operation 374, the mass analysis instrument exits the diagnostic mode and returns to a normal mode of operation. Exiting the diagnostic mode may also include ceasing or terminating the communication connection between the mass analysis instrument and the server. Accordingly, the mass analysis instrument may be isolated from the server unless the mass analysis instrument is in the diagnostic mode, providing for additional security when other samples are being tested.

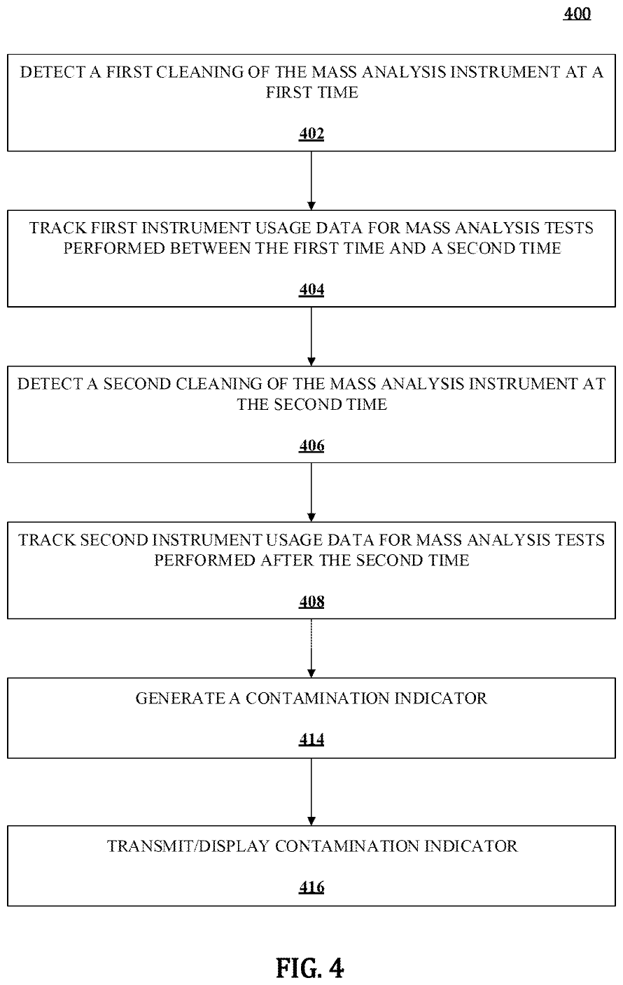

FIG. 4 depicts an example method 400 for proactively determining a contamination state of a mass analysis instrument. Method 400 may detect a pattern of cleanings and usage of the mass analysis instrument. Based on the pattern, a contamination indicator may be generated. Method 400 begins at operation 402, where a first cleaning of the mass analysis instrument is detected. Detecting the cleaning of the mass analysis instrument may be performed automatically by the mass analysis instrument itself or by another device based on the data produced by the mass analysis instrument. For example, based on a change to machine-level characteristics of the mass analysis instrument, a cleaning event may be detected to have occurred. During or subsequent to the cleaning of a mass analysis instrument, the machine-level characteristics of the mass analysis instrument change in a predictable way. In some sense, the change in machine-level characteristics may be viewed as a “fingerprint” of a cleaning event. In some examples, a switch may be activated upon the removal of a component or components normally removed during cleaning. Activation of the switch may a cause a signal to be generated that indicates a cleaning event is occurring. In other examples, detection of the cleaning may be based on receiving an input to the mass analysis instrument that indicates the cleaning has been performed. The input may be based on the selection of a button or option on the mass analysis instrument itself. For instance, upon a completion of a cleaning event, the technician may provide input into the mass analysis instrument to indicate the cleaning has been completed. The detection of the cleaning and the time (e.g., date) at which the cleaning occurred may be stored.

At operation 404, first instrument usage data for mass analysis tests performed by the mass analysis instrument are tracked after the time at which the cleaning was detected (e.g., the first time). The first instrument usage data is tracked until the next cleaning is detected (e.g., at a second time). Accordingly, the first instrument usage data is the usage data of the mass analysis instrument between the first time and the second time. The instrument usage data may include the type of tests and frequency of tests performed by the mass analysis instrument. The instrument usage data may also include machine-level characteristics, which may include system settings, for the mass analysis instrument that are stored during performance of the mass analysis tests.

At operation 406, a second cleaning of the mass analysis instrument is detected at the second time. The second cleaning of the mass analysis instrument may be detected in the same or similar manner as the first cleaning of the mass analysis instrument in operation 402. Based on the time duration or interval between the first cleaning and the second cleaning (e.g., the interval between the first time and the second time), and the first usage data, a prediction may be made regarding when the next cleaning should occur based on ongoing usage data. For instance, if the time interval between the first cleaning and the second cleaning was three months, the next cleaning should likely occur in three months if the usage data for the mass analysis instrument remains the same as it did over the time interval. If the usage of the mass analysis instrument changes, the time of the next cleaning may be adjusted based on how the usage data changes.

To facilitate such a determination or prediction, second instrument usage data for the mass analysis instrument is tracked for mass analysis tests performed after the time of the second cleaning (e.g., after the second time). Based on the time interval between the second time, the first instrument usage data, and the second usage data, a contamination indicator is generated at operation 414. The contamination indicator may include the same types of information and data discussed above. For instance, the contamination indicator may indicate the current contamination level of the mass analysis instrument. The contamination indicator may also include a predicted future contamination level of the mass analysis instrument and a predicted date by when the next cleaning should occur. The contamination indicator may be updated as additional instrument usage data is tracked after the second cleaning has occurred. For example, if at any point, the second instrument data indicates that the mass analysis instrument is being used more frequently than the mass analysis instrument was being used during the time interval between the first and second cleanings, the predicted date by when the next cleaning should occur may move closer to the current time.

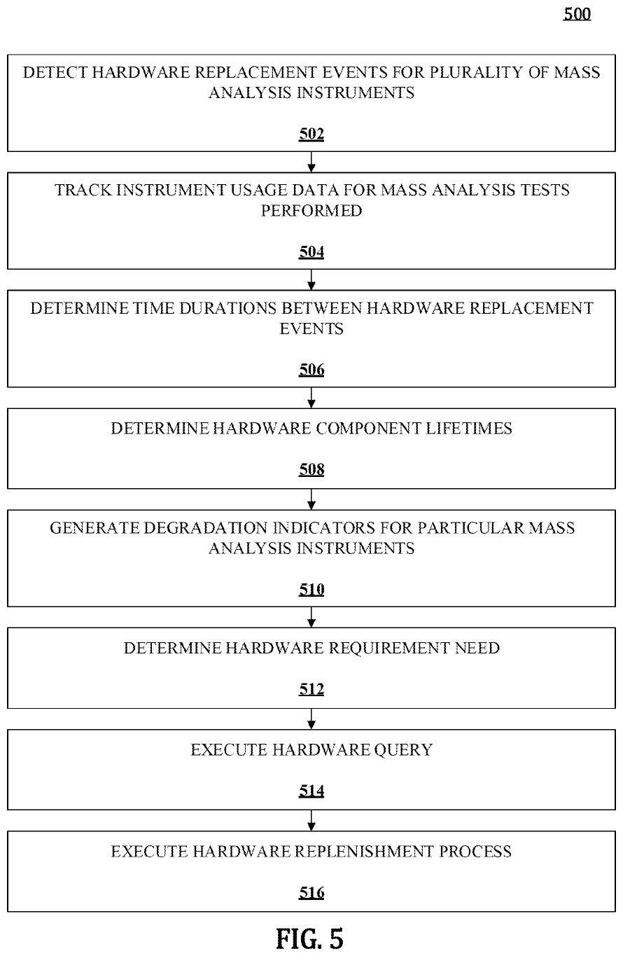

FIG. 5 depicts an example method 500 for proactively determining a degradation state of one or more mass analysis instruments. The method 500 may be utilized to predict hardware lifetimes across multiple mass analysis instruments and proactively replenish hardware supplies such that hardware is available for replacement when required. Thus, uptime for mass analysis instruments may be increased, and the hardware having limited shelf life is not wasted.

At operation 502, hardware replacement events for a plurality of mass analysis instruments are detected and/or aggregated. The plurality of mass analysis instruments may include mass analysis instruments from a particular facility or mass analysis instruments from a plurality of facilities. The mass analysis instruments from which the data is aggregated may be similarly situated mass analysis instruments, such as mass analysis instruments having similar operating conditions, being located in the same region or neighboring regions, or having similar usage or usage types, among other similarities. The hardware replacement events may be aggregated by a server, such as an on-premises server or a cloud-based server. The hardware replacement events include events where hardware of a mass analysis instrument has been replaced. The hardware that has been replaced may include consumable elements, such as filters and reagent packs, or more durable hardware, such as electrodes and detectors.

The hardware replacement events may be automatically recorded and/or detected by each of the mass analysis instruments. For example, based on a change to machine-level characteristics of the mass analysis instrument, a hardware replacement event may be detected to have occurred. Subsequent to a replacement of a hardware component, the machine-level characteristics of the mass analysis instrument may change in a predictable way. In some sense, the change in machine-level characteristics may be viewed as a “fingerprint” of a particular hardware component being replaced. In some examples, a switch may be activated upon the removal of a hardware component. Activation of the switch may a cause a signal to be generated that indicates the hardware component has been replaced. In other examples, detection of the hardware replacement event may be based on receiving an input to the mass analysis instrument that indicates a particular hardware component has been replaced. The input may be based on the selection of a button or option on the mass analysis instrument itself. For instance, upon replacing a hardware component, the technician may provide input into the mass analysis instrument to indicate that a hardware component has been replaced and the type of hardware component that has been replaced. The detection of the hardware replacement event and the time (e.g., date) at which the hardware was replaced may be stored. The hardware replacement events (including the time at which they occurred) may then be transmitted to the server and received by the server.

At operation 504, instrument usage data for mass analysis tests that are performed by the plurality of mass analysis instruments may be tracked. Tracking the instrument usage data may include each of the mass analysis instruments recording their own instrument usage data and transmitting the instrument usage data to the server. The instrument usage data may include the type of tests and frequency of tests performed by the mass analysis instrument. The instrument usage data may also include machine-level characteristics, which may include system settings, for the mass analysis instrument that are stored during performance of the mass analysis tests.

At operation 506, time durations between the hardware replacement events are determined. The time durations may be made for hardware replacement events involving the same component. For example, a time duration between replacement of an electrode may be determined. Time durations between such hardware replacement events may be determined for multiple mass analysis instruments in the plurality of mass analysis instruments.

At operation 508, hardware component lifetimes may be calculated or determined based on the time durations determined in operation 506 and the instrument usage data tracked in operation 504. For instance, a particular hardware component may have an average lifespan of one year based on the hardware replacement events aggregated from the plurality of mass analysis instruments. The actual lifespan for that particular component may differ significantly depending on how the mass analysis instrument is utilized. For instance, certain types of procedures or tests may degrade a component more quickly than other types of tests. In addition, how a sample is prepared and processed may also affect the lifetime of the hardware component. The more frequently mass analysis procedures and tests are performed, the more quickly the component may degrade. Thus, the hardware component lifetimes determined in operation 508 may be based on the types and frequency of mass analysis procedures or tests performed.

At operation 510, degradation indicators for one or more components of at least a subset of mass analysis instruments in the plurality of mass analysis instruments may be generated. The degradation indicators may be generated based on the hardware component lifetimes determined in operation 508 and instrument usage data for the subset of mass analysis instruments. For instance, a degradation indicator may be generated for an electrode of a first mass analysis instrument based on the most-recent hardware replacement event for the first mass analysis instrument where the electrode was replaced. In other words, the degradation indicator is based on the time elapsed from the time the component was last replaced and the instrument usage data since that time. A different degradation indicator may be generated for an electrode of a second mass analysis instrument and additional degradation indicators may be generated for electrodes of the other mass analysis instruments. Multiple degradation indicators may also be generated for a single mass analysis instrument. For example, a first degradation indicator may be for an electrode, a second degradation indicator may be for a detector, and a third degradation indicator may be for a filter or another hardware component. The degradation indicators may include the types of information and data discussed above. For instance, a degradation indicator may indicate the current degradation state of a component, a predicted future degradation state of the component, and/or a timeframe or deadline for when the component will need to be replaced.

At operation 512, based on the degradation indicators for the components of at least the subset of mass analysis instruments, a forecast of hardware component needs may be established. For instance, the degradation indicators may indicate that fourteen electrodes will need to be replaced in the next month. The number of replacement components that will be needed in any particular timeframe may be generated at operation 512. At operation 514, a hardware query may be executed to determine the availability of the hardware components that will need replacement over the timeframe. The executed query may be a query executed on a storage databased of hardware component inventory at a particular service center. For example, based on degradation indicators for mass analysis instruments within a particular region, a forecast of hardware components needed for the mass analysis instruments in the region may be determined. A storage database of the service center for region may be queried to determine the availability of the hardware components at the service center or within the facilities housing the mass analysis instruments. The results of the hardware query indicate the availability of the hardware components at the source that was queried.

Based on the results of the hardware query, a hardware replenishment process may be executed at operation 516. The hardware replenishment process may include generating an electronic message to request delivery of additional hardware components that are not available within the timeframe at which the hardware components of the mass analysis instruments will need to be replaced. By proactively ensuring that the hardware components are available when they will need to be replaced, the hardware components may be replaced in a timely manner that leads to an increased uptime of the mass analysis instruments. In addition, hardware components may be replenished on an as-needed basis, which leads to less hardware requirements from having to be stored for extended periods of time. Such a benefit is particularly useful for hardware components that have limited shelf lives.

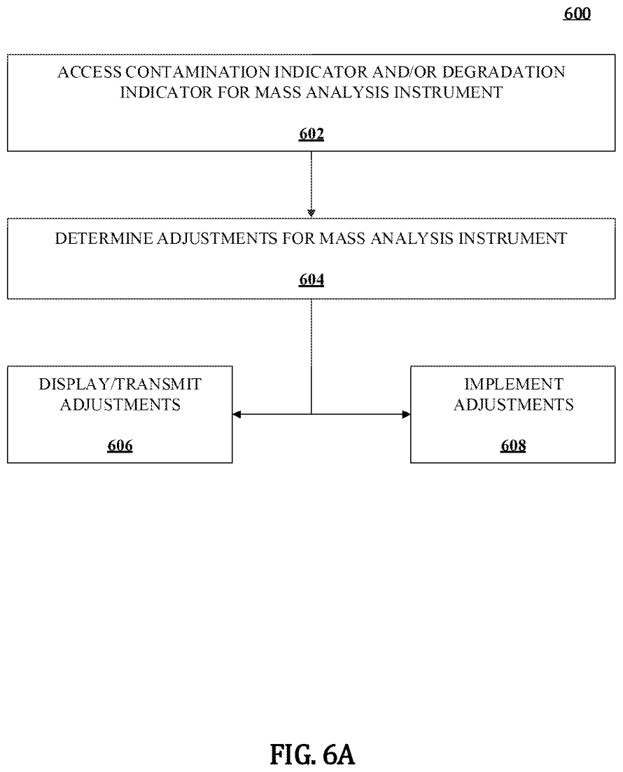

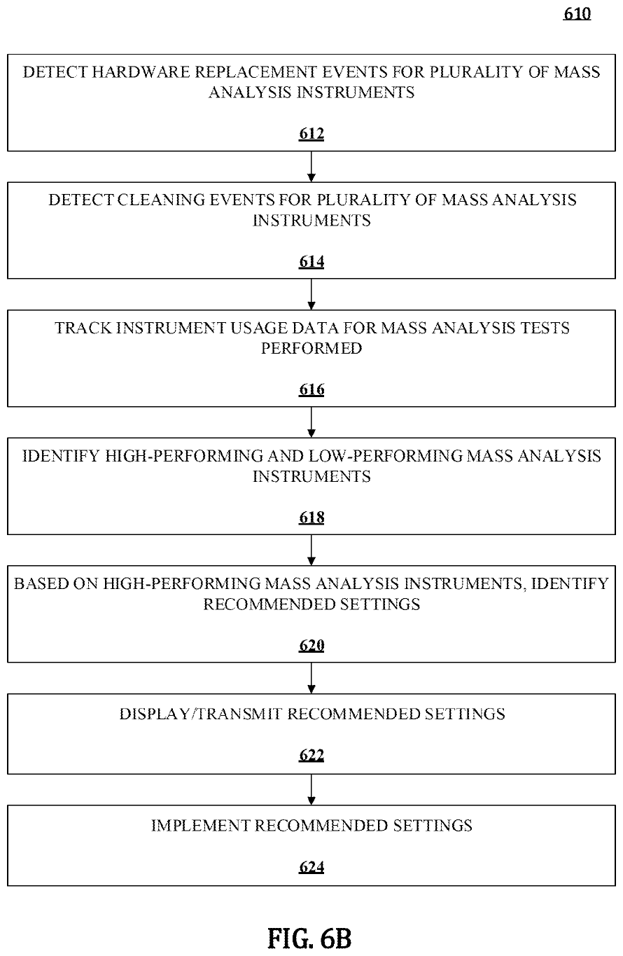

FIG. 6A depicts an example method 600 for improving operation of one or more mass analysis instruments. Method 600 determines settings of a mass analysis instrument that may be changed to improve results of the mass analysis instrument and/or extend the lifetime of components within the mass analysis instrument. The settings that are to be changed may be based on analysis of data from a plurality of mass analysis instruments to determine which settings are likely to improve operation and/or lifetime of the mass analysis instrument or its components. The settings may be automatically changed or displayed as a recommendation.

At operation 602, a contamination indicator and/or degradation indicator for a mass analysis instrument may be accessed or received. The contamination indicator and/or degradation indicator may have been generated using any of the methods or processes described herein. Based on the contamination indicator and/or degradation indicator, adjustments for the mass analysis instrument may be determined at operation 604. Determining the adjustments for the mass analysis instrument may be based on the type of component that is contaminated or degraded along with the severity of the contamination or degradation. Adjustments to the mass analysis instrument to overcome or compensate for that contamination or degradation may then be determined. The adjustments to the mass analysis instrument may include adjustments to the settings of the mass analysis instrument or other changes to workflows for performing tests with the mass analysis instrument. For example, where a degradation indicator for a detector of the mass analysis instrument indicates that the detector is nearing the end of its life, the determined adjustment to the mass analysis instrument may be an increase in voltage to restore performance of the detector until the detector can be replaced.

Once the adjustments to the mass analysis instrument are determined, the adjustments may be displayed or transmitted in operation 606 and/or the adjustments may be automatically implemented by the mass analysis instrument in operation 608. The adjustments may be displayed or transmitted in a similar manner as the contamination indicator and/or degradation indicator as discussed herein. For example, the adjustments may be displayed directly on the mass analysis instrument itself, displayed through a web-based dashboard, and/or transmitted in an electronic message.

FIG. 6B depicts an example method 610 for improving operation of one or more mass analysis instruments. Method 610 leverages aggregated data from a plurality of mass analysis instruments to determine best or recommended settings or workflows for mass analysis instruments to increase uptime or lifespans of mass analysis instruments. For example, analysis of the aggregated data may indicate that some mass analysis instruments have components that degrade or become contaminated more quickly than other mass analysis instruments despite being used at roughly the same frequency. The differences in settings and workflows for the mass analysis instruments that degrade more slowly may be recommended as adjustments for the mass analysis instruments that degrade more quickly.

Method 610 begins at operation 612 where hardware replacement events for a plurality of mass analysis instruments are detected and/or aggregated. The plurality of mass analysis instruments may include mass analysis instruments from a particular facility or mass analysis instruments from a plurality of facilities. The mass analysis instruments from which the data is aggregated may be similarly situated mass analysis instruments, such as mass analysis instruments having similar operating conditions, being located in the same region or neighboring regions, or having similar usage or usage types, among other similarities. The hardware replacement events may be aggregated by a server, such as an on-premises server or a cloud-based server. The hardware replacements events include events where hardware of a mass analysis instrument has been replaced. The hardware that has been replaced may include consumable elements, such as filters and reagent packs, or more durable hardware, such as electrodes and detectors.

The hardware replacement events may be automatically recorded and/or detected by each of the mass analysis instruments. For example, based on a change to machine-level characteristics of the mass analysis instrument, a hardware replacement event may be detected to have occurred. Subsequent to a replacement of a hardware component, the machine-level characteristics of the mass analysis instrument may change in a predictable way. In some sense, the change in machine-level characteristics may be viewed as a “fingerprint” of a particular hardware component being replaced. In some examples, a switch may be activated upon the removal of a hardware component. Activation of the switch may cause a signal to be generated that indicates the hardware component has been replaced. In other examples, detection of the cleaning may be based on receiving an input to the mass analysis instrument that indicates a particular hardware component has been replaced. The input may be based on the selection of a button or option on the mass analysis instrument itself. For instance, upon replacing a hardware component, the technician may provide input into the mass analysis instrument to indicate that a hardware component has been replaced and the type of hardware component that has been replaced. The detection of the hardware replacement event and the time (e.g., date) at which the hardware was replaced may be stored. The hardware replacement events (including the time at which they occurred) may then be transmitted to the server and received by the server.

At operation 614, cleaning events for the plurality of mass analysis instruments are detected and/or aggregated. The cleaning events may be detected automatically and/or based on input received at the mass analysis instrument, as discussed above. At operation 616, instrument usage data for mass analysis tests that are performed by the plurality of mass analysis instruments may be tracked. Tracking the instrument usage data may include each of the mass analysis instruments recording their own instrument usage data and transmitting the instrument usage data to the server. The instrument usage data may include the type of tests and frequency of tests performed by the mass analysis instrument. The instrument usage data may also include machine-level characteristics, which may include system settings, for the mass analysis instrument that are stored during performance of the mass analysis tests. The instrument usage data may further include data regarding workflows or procedures that are performed as part of the mass analysis tests.

At operation 618, high-performing mass analysis instruments and low-performing mass analysis instruments are identified based on the hardware replacement events, the cleaning events, and/or the instrument usage data. The high-performing mass analysis instruments may be mass analysis instruments that have an above-average lifespan for one or more components. The high-performing mass analysis instruments may also be the mass analysis instruments that have below-average cleaning frequency (e.g., require cleaning less frequently). In turn, the low-performing mass analysis instruments may be mass analysis instruments that have a below-average lifespan for one or more components. The low-performing mass analysis instruments may be mass analysis instruments that have an above-average cleaning frequency (e.g., require cleaning more frequently).

The average lifespan of the components of the plurality of mass analysis instruments may be determined based on the hardware replacement events and the instrument usage data. The average lifespan of the components may be represented as a number of tests of particular types. For instance, an average lifespan of a filter may be one replacement per 100 tests of a certain type. Some mass analysis instruments may have a higher or lower average lifespan and may be classified accordingly.

Similarly, the average cleaning frequency may be based on the cleaning events and the instrument usage data. The average cleaning frequency may be represented as a number of tests of particular types. For instance, an average cleaning frequency for a mass analysis instrument may be one cleaning per 50 tests of a particular type. Some mass analysis instruments may have a higher or lower cleaning frequency and may be classified accordingly.

Based on the classification of the high-performing mass analysis instruments and the low-performing mass analysis instruments, recommended settings may be identified in operation 620. Identification of the recommended settings may be based on a comparison of the instrument usage data for the high-performing mass analysis instruments and the instrument usage data for the low-performing mass analysis instruments. For example, differences in the instrument usage data between the high-performing mass analysis instruments and the low-performing mass analysis instruments may indicate the settings, machine-level characteristics, and/or workflows that may be preferable for extending the lifespan or cleanliness of a mass analysis instrument.

One example setting that may be identified as a recommended setting is a curtain gas parameter setting. The curtain gas parameter setting helps prevent dirt and debris from entering the mass analysis instrument. The curtain gas parameter setting has an adjustable range. Users often run the curtain gas parameter setting at the lowest minimum setting because the perception is that operating at the lowest setting increases sensitivity or accuracy, but that is not always the case. In many cases, increasing the parameter does not affect sensitivity or accuracy. Based on a comparison of the instrument usage data of the high-performing mass analysis instruments and the low-performing mass analysis instruments, an identification may be made for a particular curtain gas parameter setting. For instance, the high-performing mass analysis instruments may be operating the curtain gas parameter setting at a higher value than the low-performing mass analysis instruments. As such, a higher curtain gas parameter setting may be generated as a recommended setting for the low-performing mass analysis instruments.

Another example setting that may be identified as a recommended setting is an ionization voltage setting. In some cases, a user may run a test on a dirty sample but may be interested in only the back half of the results. The front half of the sample includes salts and are not of interest to the user. The salts, however, more quickly contaminate the mass analysis instrument if they are analyzed. To help prevent such a rapid contamination, the ionization voltage may be turned off during the receipt of the beginning of the sample from an LC column such that the beginning of the sample containing the salts is not accelerated. Rather, the salts can be flushed out of the system. Based on a comparison of the instrument usage data of the high-performing mass analysis instruments and the low-performing mass analysis instruments, an identification may be made that the high-performing mass analysis instruments may be performing the suspension of ionization voltage operation but the low-performing mass analysis instruments are not. Thus, the recommended setting may include a recommendation to perform the suspension of ionization voltage operation.

At operation 622, the recommended settings may be displayed on one or more of the low-performing mass analysis instruments and/or displayed on a web-based dashboard for the low-performing mass analysis instruments. The recommended settings may also be transmitted via an electronic message. At operation 624, the recommended settings may be automatically implemented on one or more of the low-performing mass analysis instruments.

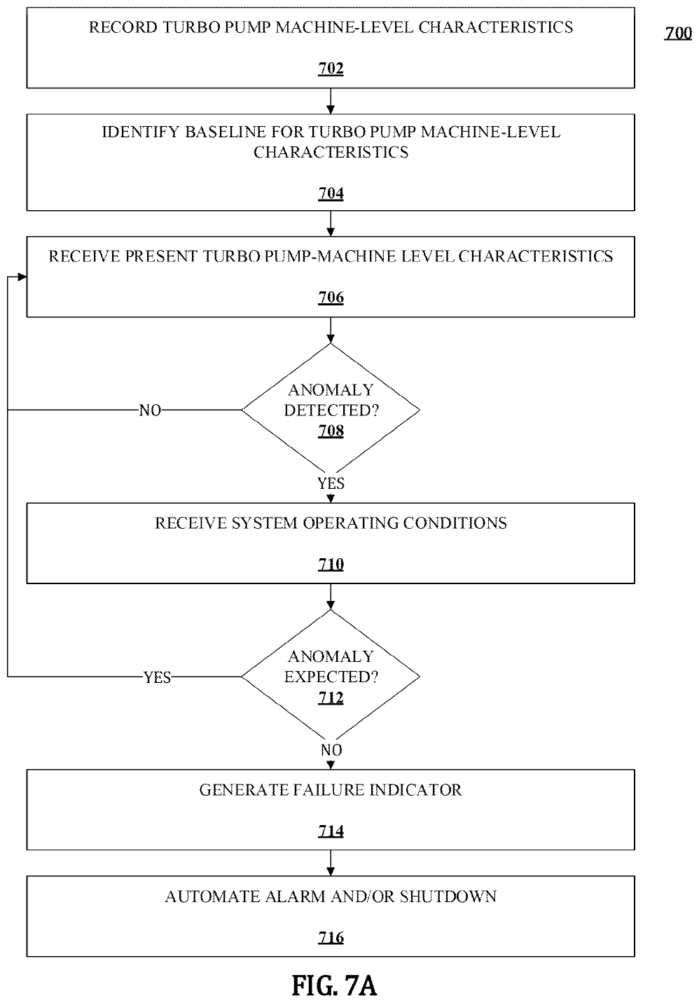

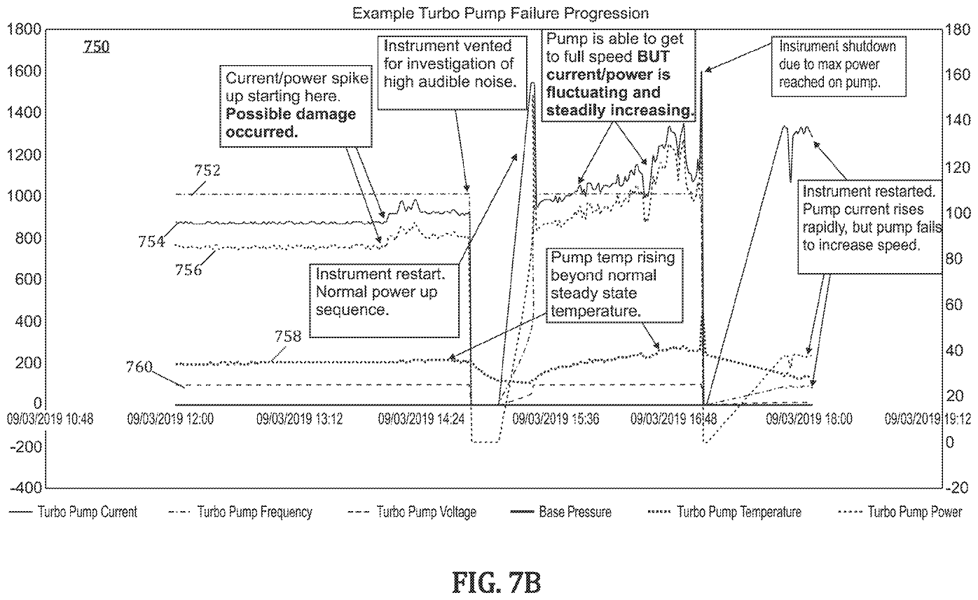

FIG. 7A depicts an example method 700 for predicting a failure of a turbo pump. Turbo pump failures, like other component failures, render the mass analysis instrument inoperable. As an example of such a failure, when a turbo pump of a mass analysis instrument fails, the result can be catastrophic as the rotor may fragment and cause damage to other components, such as the ion optics components. Accordingly, there is a benefit to predicting when such a failure may occur so that the turbo pump can be maintained or replaced prior to such a failure occurring. Method 700 may allow for predicting imminent pump failures which provides advance notification to allow for early intervention before a customer experiences a down system.

At operation 702, turbo pump machine-level characteristics are recorded and/or accessed. The turbo pump machine-level characteristics may include the turbo pump frequency, the turbo pump current, the turbo pump power, the turbo pump temperature, and the turbo pump voltage, among other things. At operation 704, a baseline for the turbo pump machine-level characteristics may be determined. The baseline may be determined for each or a subset of the turbo pump machine-level characteristics. The baseline may be determined from the turbo pump machine-level characteristics when the turbo pump is operating under normal, functional conditions. In an example, the baseline for each of the turbo pump machine-level characteristics may be the average turbo pump machine-level characteristic during a particular operating mode, such as spinning up or at a steady state operation.

At operation 706, present turbo pump machine-level characteristics are received. The present turbo pump machine-level characteristics may be turbo pump machine-level characteristics that are reported on a substantially live or real-time basis. At operation 708, a determination is made as to whether there is an anomaly in the present turbo pump machine-level characteristics. Determining the presence of the anomaly may be based on a comparison of the present turbo pump machine-level characteristics to the baseline determined in operation 704. If the present turbo pump machine-level characteristics are within a tolerance from the baseline, no anomaly is determined to have occurred, and method 700 flows back to operation 706 where new present turbo pump machine-level characteristics are received. If, however, at operation 708, one or more present turbo pump machine-level characteristics are outside of a tolerance from the baseline, an anomaly may be determined to have occurred and method 700 flows to operation 710. For instance, if the temperature and or current of the turbo pump are above a threshold or tolerance above the baseline, an anomaly is determined to have occurred.

At operation 710, system operating conditions for the mass analysis instrument are received or accessed. The system operating conditions may include conditions such as vacuum pressures, gas loads, heater temperatures, among other conditions. At operation 712, the system operating conditions may be used to determine whether the anomaly detected at operation 708 was expected or can be explained by other factors other than an impending turbo pump failure. For example, if the system operating conditions indicate that a heater temperature is above a usual heater temperature, an anomaly based on an increase in turbo pump temperature may have been expected. If the anomaly is determined to be expected in operation 712, the method 700 flows back to operation 706 where new present turbo pump machine-level characteristics are received. If, however, the anomaly is determined to not be expected in operation 712, the method 700 flows to operation 714.

At operation 714, a failure indicator is generated for the turbo pump. The failure indicator may indicate a predicted failure time for the turbo pump. Depending on the type of anomaly detected, the failure time may be from minutes to days. The failure indicator may be displayed on the mass analysis instrument or through a web-based dashboard. The failure indicator may also be transmitted via an electronic message.

At operation 716, based on the predicted failure time in the failure indicator, an alarm may be activated and/or the turbo pump may be automatically shut down. For example, where the predicted failure time is minutes, the turbo pump may be automatically shut down to prevent a potential catastrophic failure. An alarm may also be sounded. In other examples where the failure is less imminent, an alarm may be activated, but the turbo pump may continue operating.

While the method 700 has been described specific to a turbo pump, it should be appreciated that the method 700 may be applied to other components of the mass analysis instrument. For example, the machine-level characteristics for that particular component may be utilized rather than the turbo pump machine-level characteristics.

FIG. 7B depicts an example plot 750 of machine-level characteristics for a turbo pump. In the example plot 750, the turbo pump frequency 752, the turbo pump current 754, the turbo pump power 756, the turbo pump temperature 758, and the turbo pump voltage 760 are plotted against time. Several indicators of potential events are depicted in the plot 750. For instance, just prior to 14:24, there is a spike in current 754 and power 756, which may be indicative of degradation or damage of the turbo pump. At the same time, an increase in temperature 758 is also observed. Between 14:24 and 15:36, the turbo pump is shut down and restarted. Upon restart, the current 754 and power 756 increase beyond the levels seen prior to the restart, and the temperature 758 continues to increase, potentially signaling potential damage or malfunction. The turbo pump is then restarted again at which point, the current 754 reaches high levels, but the voltage 760 and thus the power 756 remain low. In addition, the frequency of the turbo pump is only able to reach 85 Hz, which is insufficient to reduce pressure to the vacuum levels. Thus, the turbo pump has failed. A prediction of the impending failure may have been generated based on increased current 754, power 756, and temperature 758 of the turbo pump prior around 14:24 or just prior to 16:48.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved. In addition, the operations depicted in the block diagram may be performed by a suitable computing device, such as the computing components within a mass analysis instrument, an on-premises server, and/or a cloud-based server.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurement techniques utilized herein. To the extent such terms may not be clearly defined or understood by one having skill in the art, the term “about” shall mean plus or minus ten percent.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

1. A system for improved mass analysis operation by proactively identifying contamination or degradation, the system comprising:
a mass analysis instrument comprising mass analysis hardware components;
a processor; and
memory storing instructions that, when executed by the processor, cause the system to perform a set of operations, the set of operations comprising:
performing, by the mass analysis instrument at a first time, a predefined series of operational tests to produce first mass analysis results for a calibrant;
performing, by the mass analysis instrument at a second time, the predefined series of operational tests to produce second mass analysis results for the calibrant;
determining an analysis difference between the first mass analysis results and the second mass analysis results; and
based on a magnitude of the analysis difference, generating at least one of a contamination indicator or a degradation indicator.

2. The system of claim 1, wherein the processor and memory are incorporated into the mass analysis instrument.

3. The system of claim 1, wherein the processor and memory are incorporated into a server remotely located from the mass analysis instrument.

4. The system of claim 1, wherein the operational tests include at least one of a polarity test or a ramping test.

5. The system of claim 1, wherein generating the contamination indicator is further based on whether the analysis difference is positive or negative.

6. The system of claim 1, wherein the operations further comprise:
storing, at the first time, first machine-level characteristics for the mass analysis instrument;
storing, at the second time, second machine-level characteristics for the mass analysis instrument;
determining a machine-level difference between the first machine-level characteristics for the mass analysis instrument; and
wherein generating the at least one of the contamination indicator or the degradation indicator is further based on the machine-level difference.

7. The system of claim 6, wherein the machine-level characteristics include at least a voltage level, a current, and a temperature.

8. The system of claim 1, wherein:
the mass analysis instrument further comprises a display; and
the operations further comprise displaying at least one of the contamination indicator or the degradation indicator on the display.

9. (canceled)

10. The system of claim 1, wherein the operations further comprise at least one of:
causing display of at least one of the contamination indicator or the degradation indicator in a web-based dashboard; or
transmitting at least one of the contamination indicator or the degradation indicator in an electronic communication.

11. The system of claim 1, wherein the contamination indicator indicates a current level of contamination.

12. The system of claim 1, wherein the contamination indicator indicates a predicted future level of contamination.

13. The system of claim 1, wherein the degradation indicator indicates a current level of degradation of a hardware component of the mass analysis instrument.

14. The system of claim 1, wherein the degradation indicator indicates a predicted future level of degradation of a hardware component of the mass analysis instrument.

15. The system of claim 1, wherein the operations further comprise based on the contamination indicator, scheduling a cleaning of the mass analysis hardware to remove the contamination.

16. (canceled)

17. The system of claim 1, wherein the mass analysis instrument is configured to automatically perform the predefined series of operational tests upon receipt of the calibrant.

18. The system of claim 1, wherein the operations further comprise:
detecting, by the mass analysis instrument, receipt of the calibrant; and
based on detecting receipt of the calibrant, automatically performing the predefined series of operational tests.

19. The system of claim 1, wherein the mass analysis instrument is configured to automatically perform the predefined series of operational tests upon receiving an input at the mass analysis instrument to enter a diagnostic mode.

20. The system of claim 1, wherein the at least one of the contamination indicator or the degradation indicator are generated by a trained machine learning model, wherein the trained machine learning model has been trained on prior mass analysis results from a plurality of mass analysis instruments.

21-63. (canceled)

64. A system for improved mass analysis operation, the system comprising:
a mass analysis instrument comprising a turbo pump;
a processor; and
memory storing instructions that, when executed by the processor, cause the system to perform a set of operations, the set of operations comprising:
accessing turbo pump machine-level characteristics;
identifying a baseline for the turbo pump machine-level characteristics;
receiving present turbo pump machine-level characteristics;
based on a comparison of the present turbo pump machine-level characteristics and the identified baseline, determining an anomaly has occurred;
receiving system operating conditions;
based on the system operating conditions, determining that the anomaly is not expected;
generating a failure indicator; and
performing at least one of:
activating an alarm based on the failure indicator; or
shutting down the turbo pump based on the failure indicator.

65-66. (canceled)

67. A system for improved mass analysis operation, the system comprising:
a mass analysis instrument comprising a hardware component;
a processor; and
memory storing instructions that, when executed by the processor, cause the system to perform a set of operations, the set of operations comprising:
accessing machine-level characteristics for the hardware component;
identifying a baseline for the machine-level characteristics for the hardware component;
receiving present machine-level characteristics for the hardware component;
based on a comparison of the present machine-level characteristics and the identified baseline, determining an anomaly has occurred;
receiving system operating conditions;
based on the system operating conditions, determining that the anomaly is not expected;
generating a failure indicator; and
performing at least one of:
activating an alarm based on the failure indicator; or
shutting down hardware component based on the failure indicator.

68-77. (canceled)
